(19) United States
(12) Patent Application Publication
(10) Pub. No.: US 2007/0226053 A1
(43) Pub. Date: Sep. 27, 2007

(54) System for uploading video advertisements, solicit user feedback, and create ratings/rankings

(76) Inventors: Kevin Carl, Vienna, VA (US); Leslie Carl, Vienna, VA (US)

Correspondence Address: GREENBERG TRAURIG, LLP, 1750 TYSONS BOULEVARD, 12TH FLOOR, MCLEAN, VA, 22102, US

(21) Appl. No.: 11/386,069

(22) Filed: Mar. 21, 2006

(51) Int. Cl. G06Q 30/00

(52) U.S. Cl. 705/14

(57) ABSTRACT

A method for uploading rating a multimedia advertising comprising of the steps providing web service for storing a plurality of applications programs for permitting an advertiser to place a multimedia advertisement for review by an end user; providing a first user interface for an advertiser to upload a multimedia advertisement with the web service; and providing a second user interface for an end user to view the advertisement and rate the advertisement based upon at least one rating criteria.

### FIELD OF THE INVENTION

The present invention is directed to the field of online advertising. In particular, the patent invention is directed to the field of online advertising in which advertisements can be viewed via an online interface and rated or ranked.

### BACKGROUND OF THE INVENTION

Since the inception of the Internet, online advertising has been an important and critical component of ecommerce. Thousands of websites, web portals and the like earn significant revenues from advertisements. With the emergence of broadband technologies, there has been a rapid increase in the usage of online multimedia advertising. Major websites post multimedia advertisements, which are often the exact same ads which appear on television.

With broadband communications, in a matter of seconds, Internet users can download, access or view a large number of multimedia advertisements. Creative television and multimedia advertisements have been shown to have a tremendous impact on the sales and market awareness of advertisers. Each year, an award called the CLIO is granted for creative advertisements. The annual Superbowl in the USA has become a national forum for companies to air creative and entertaining ads.

It's often difficult for small companies to get valuable feedback on commercials or multimedia presentations. Small companies often write and produce creative and artistic advertisements or important multimedia informational pieces but lack the financial resources to give them broad dissemination. The lack of such broad dissemination impedes the ability of smaller companies to get their ads out and to grow their businesses.

Real feedback from commercials is also difficult to obtain and expensive. Each year, large corporations spend billions on marketing and advertising and analyzing why consumers buy their products.

There have been a number of patents directed to the field of online advertising. U.S. Pat. No. 5,903,635 dated May 11, 1999 to Kaplan discloses an advertising effectiveness rating system provides advertising effectiveness rating data by assigning one telephone number to each of a plurality of advertising outlets and counting the number of times that each of the assigned telephone numbers are used. The advertising effectiveness rating system includes an advertising effectiveness rating device that receives a called number from a local switch. When a prospective purchaser calls one of the assigned telephone numbers, the local switch forwards the called number to the advertising effectiveness rating device. When a called number is received, the advertising effectiveness rating device retrieves a count that corresponds to the called number from a database, increments the count and returns the incremented count to the database. When a request for advertising effectiveness rating data is received, a controller of the advertising effectiveness rate device retrieves the database, formats the data in the database, and outputs the formatted data as the advertising effectiveness rating data.

U.S. Pat. No. 6,470,079 dated Oct. 22, 2002 to Benson discloses a telecommunications environment includes a switch for connecting calls placed by a caller in response to an advertising campaign. The advertising campaign is identified by a particular directory number (the “campaign number”). The switch monitors calling information related to the call and forwards that calling information to a data recorder. The calling information includes the directory number of the party placing the call, the directory number called, whether the call was connected, the duration of the call, and other information. The data recorder passes the calling information for each advertising campaign to a web server where the calling information is accessible over the Internet. In this manner, a subscriber may connect to the web server over the Internet and request a report on the effectiveness of the advertising campaign.

U.S. Pat. No. 6,286,005 dated Sep. 4, 2001 to Cannon discloses a computer-based decision support system that includes three main components: a database mining engine (DME); an advertising optimization mechanism; and a customized user interface that provides access to the various features of the invention. The user interface, in conjunction with the DME, provides a unique and innovative way to store, retrieve and manipulate data from existing databases containing media-related audience access data, which describe the access habits and preferences of the media audience. By using a database with a simplified storage and retrieval protocol, the data contained therein can be effectively manipulated in real time. This means that previously complex and lengthy information retrieval and analysis activities can be accomplished in very short periods of time (typically seconds instead of minutes or even hours). Further, by utilizing the advertising optimization mechanism of the present invention, businesses, networks, and advertising agencies can interactively create, score, rank and compare various proposed or actual advertising strategies in a simple and efficient manner. This allows the decision-makers to more effectively tailor their marketing efforts and successfully reach the desired target market while conserving scarce advertising capital. Finally, the user interface for the system provides access to both the DME and the optimization mechanism in a simple and straightforward manner, significantly reducing training time.

U.S. Pat. No. 6,654,725 dated Nov. 25, 2003 to Langheinrich discloses a system and method for customized advertisement selection and delivery on the World Wide Web (WWW) upon the Internet. The advertising system has a database server which stores advertisements and their campaign information, and an advertisement server which generates electronic advertisements available to a client system. In the system, a customization process which customized the electronic advertisements to be delivered to each client system is performed. A user connects to a web site and is presented with an editorial page or a list of search results. The system inserts a customized advertisement into the page that matches the page content or search topic. No identifiable data is collected during the interaction with the user. Advertisers can specify display constraints for each advertisement. The system will adapt all unrestricted parameters in order to maximize the user's click-through probability.

While there have been a large number of systems related to online advertising, there have been no easy systems to place advertising for review and analysis by the public.

It would be desirable to provide a system by which small companies could cost effectively present advertisements to the public.

It is an object of the present invention to provide a system for permitting advertisers to upload advertisements for viewing by the end user.

It is a further object of its present invention to provide a system in which end users can vote on or rate advertisements.

It is a further object of the present invention to provide a method, and system by which advertisements so scored and rated can be placed on or referred to via “Top Ten” and “Best of” webpages.

It is still a further object of its present invention to provide a system in which an online user can see and rate an advertisement.

It is still a further object of the present invention to provide a system in which advertisers can pay a flat fee or subscription fee to have their ads viewed and rated by the public.

It is a further object of the present invention to provide a system whereby advertising can be placed, and be constantly accessible to end users.

It is a further object of the present invention to provide a system whereby location data such as latitude, longitude and elevation data can be stored in association with the advertisement to facilitate end user search based on location.

These and other objects of the present invention will become apparent from the detailed description which follows.

### SUMMARY OF THE INVENTION

In accordance with the present invention, the invention is a method for uploading and rating a multimedia advertisement comprising the following steps of providing web service for storing a plurality of applications programs for permitting an advertiser to place a multimedia advertisement for review by an end user; providing a first user interface for an advertiser to upload a multimedia advertisement with the web service; and providing a second user interface for an end user to view the advertisement and rate the advertisement based upon at least one rating criterion.

In a further embodiment, the present invention is a method for uploading and rating a multimedia advertising comprising the following steps for providing a web service for storing a plurality of secure application programs for permitting an advertiser to place a multimedia advertisement for review and rating by an end user; providing a first user interface for an advertiser to log on, subscribe and upload a multimedia advertisement with the web service; and providing a second user interface for an end user to view the uploaded advertisement and to rate the advertisement based upon at least one rating criteria.

In yet another embodiment, the invention is a method for uploading and rating advertising comprising the following steps for providing a web service for storing a plurality of applications programs for permitting an advertiser to place a multimedia advertisement for review by an end user; providing a first user interface for an advertiser to log on, subscribe and upload a multimedia advertisement on the web service; providing a second user interface for an end user to view the advertisement and rate the advertisement based upon a plurality of rating criteria; and providing a third interface for displaying a plurality of advertisements listed according to their ratings.

In still a further embodiment, the invention is a system for uploading, displaying and rating multimedia advertisement a web service for storing a plurality of application programs for permitting an advertiser to place a multimedia advertisement for viewing by end users; a first user interface associated with the web service for enabling an advertiser to log in, subscribe and to upload said multimedia advertisement; and a second user interface associated with the web browser for enabling an end user to access the web service to select a multimedia advertisement for viewing and for inputting rating data; and a third interface for providing a listed ranking of the said first user interface enabling the advertiser to review and search rating data.

### BRIEF DESCRIPTION OF THE FIGURES

FIG. 1 is an overview of a simple embodiment of the present invention.

FIG. 2 is a diagram of a user interface in accordance with the present invention.

FIG. 3 is a simple advertiser user screen.

FIG. 4 is a flow chart overview of the system.

FIG. 5 is a flow diagram for login creation by an advertiser.

FIG. 6 illustrates the form for login creation by an advertiser.

FIG. 7 illustrates the form for choosing a user id and password by an advertiser.

FIG. 8 is a flow diagram for advertiser account activation.

FIG. 9 illustrates the page notifying the advertiser of registration and prompting the advertiser to complete the account activation process.

FIG. 10 illustrates the screen that the advertiser sees upon login to the account.

FIG. 11 illustrates the procedure for a user to enter a business or event name, description, miscellaneous information and location information and to upload a video in accordance with the present invention.

FIG. 12 illustrates an overview of the technical aspects of video upload in accordance with the present invention.

FIG. 13 is a flow diagram for setup of the advertiser account

FIG. 14 illustrates the screen on which the advertiser selects that they are advertising a business or event.

FIG. 15 illustrates the screen on which the advertiser submits information related to a business.

FIG. 16 illustrates the screen on which the advertiser submits the video file.

FIG. 17 illustrates the screen on which the advertiser submits location information by street address or by combination of latitude, longitude and (optionally) by elevation.

FIG. 18 is a flow diagram overview of the system to store latitude and longitude technical information in accordance with the present invention.

FIG. 19 illustrates the screen on which the advertiser selects whether to continue adding locations or not.

FIG. 20 illustrates the screen on which the advertiser submits discount offer information.

FIG. 21 illustrates an example of how the discount offer is displayed online.

FIG. 22 is a flow diagram overview of the system to allow the user to create a video campaign for a business or event that is targeted to specific locations and which allows the advertiser to present a different discount offer for each location.

FIG. 23 illustrates the screen on which the advertiser selects the already-submitted Business or Event from a drop-down box on the screen.

FIG. 24 illustrates an example of the screen on which the advertiser selects which of the already-submitted videos is to be advertised.

FIG. 25 illustrates an example of the screen on which the advertiser selects which of the already-submitted locations is to be advertised.

FIG. 26 illustrates the screen on which the advertiser can select which discount offer, if any, is to be presented for each location.

FIG. 27 illustrates the summary page that summarizes the advertiser's business or event, location and offer selections.

FIG. 28 is a flow diagram overview of the system to allow the user to add additional addresses.

FIG. 29 is a flow diagram overview of the system to allow the user to review the advertisement as it will appear to the online user, to select whether to accept or modify the advertisement, and to select a start and end date for the advertisement.

FIG. 30 illustrates a screen that the advertiser will use to review the advertisement.

FIG. 31 illustrates a summary screen and the selection of the start and end dates for the advertisement.

FIG. 32 is a flow diagram overview of the pay subscription model in accordance with the present invention.

FIG. 33 illustrates a summary screen of expenses as calculated by the system and presented to the user for payment.

FIG. 34 illustrates a process by which a third party operator verifies content in accordance with the present invention.

FIG. 35 discloses the system by which the system makes a video available for search in accordance with the present invention.

FIG. 36 is a flow diagram of an end user search function in accordance with the present invention.

FIG. 37 is an illustration of a search form in which an end user submits a search query to the system.

FIG. 38 shows an advanced end user search function in accordance with the present invention.

FIG. 39 illustrates a screen in which the system renders search results listing and the geographic locations depicted on a map.

FIG. 40 illustrates an overview of the technical aspects of search in accordance with the present invention.

FIG. 41 illustrates the steps by which the end user can select and view video in accordance with the present invention.

FIG. 42 illustrates an overview of the end user display video function in accordance with the present invention.

FIG. 43 illustrates an overview of the technical aspects of end user video display in accordance with the present invention.

FIG. 44 is an overview of the system to rate ads in accordance with the present invention.

FIGS. 45a and 45b illustrate the system by which the end user rates videos in accordance with the present invention.

FIG. 46 discloses the system by which the end user rates videos in accordance with the present invention.

FIG. 47 illustrates the system for aggregating statistics in accordance with the present invention.

FIG. 48 illustrates a system for displaying a “Top 10” or “Best Of” ads.

FIG. 49 illustrates a system for providing the advertiser with ad performance information.

### DETAILED DESCRIPTION OF THE INVENTION

The present invention is described with reference to the enclosed Figures wherein the same numbers are utilized where applicable. In a most preferred embodiment, the invention is a system which allows an end user, such as a business or commercial venture to upload video advertisements, to solicit user feedback and to receive ratings and rankings for the advertisements.

In particular, the present invention provides a system whereby an advertiser can upload a multimedia advertisement. The uploaded advertisements can then be viewed by an end user such as a consumer or potential customer. The end user consumer can view the advertisement and vote on, rate or rank it. In one embodiment, top rated advertisements can then be viewed on a webpage within the system or placed on a website such as “TopTenAds.com” or a “Best of” website to be viewed by the public.

The invention can also encompass a searchable database whereby ads can be searched and played selectively by members of the public. Advertisements can be searched by subject area, keyword or geography.

An interactive website is envisioned pursuant to the present invention. The website, which may be run by a third party commercial enterprise, will provide an interface for advertisers to upload advertisements and related information. A second interface permits a user to view a plurality of advertisements and to vote and rate them.

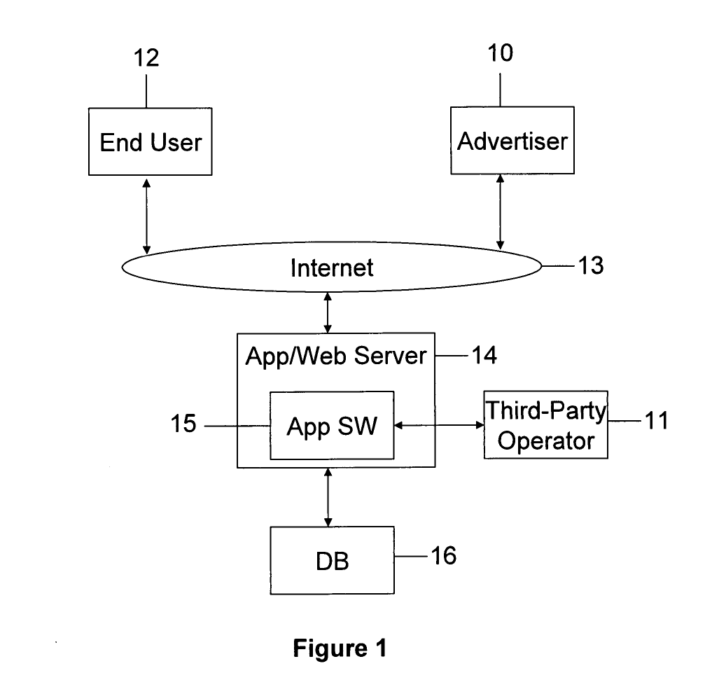

As shown in FIG. 1, the simplest embodiment of the invention comprises an end user advertiser 10, a third-party operator 11 and an end user consumer 12. The advertiser 10, third-party operator 11 and end user 12 will typically have a device such as PC computer, Lap Top or other system with an Internet browser or similar capability. The end user and advertiser are connected to the Internet 13.

The invention includes an application server and web server 14 which may be one and the same, typically associated with a third party enterprise which includes and hosts a series of software and web applications 15 which enable the uploading or linking of multimedia advertisements by the advertiser which can then be searched, viewed and rated by the end user. The system will include a database 16.

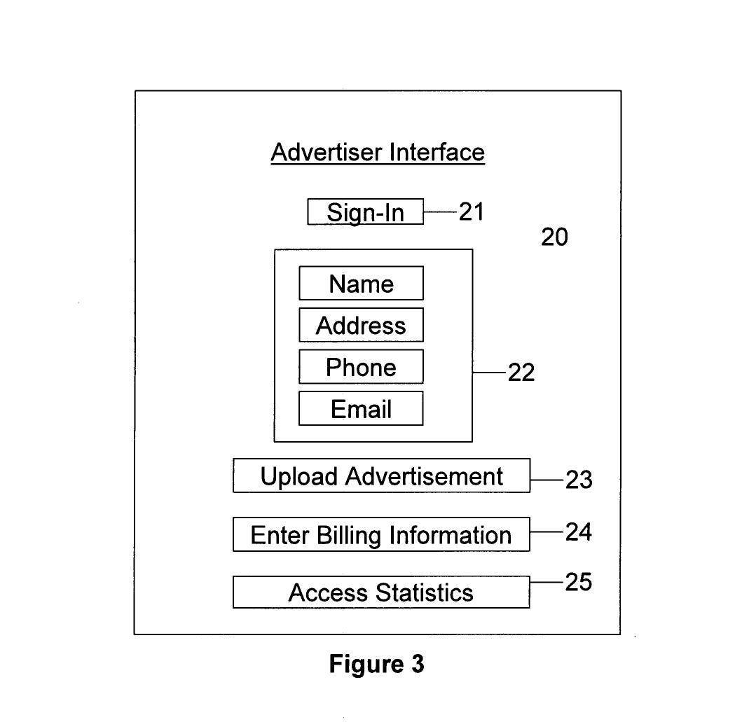

Referring to FIG. 3, in a broad embodiment, the advertisers and end users are presented with a series of user screens 20 and functionalities for facilitating the operation of the invention. In general, the advertiser is presented with a sign-in area 21, an area to create an account 22, an area which facilitates the uploading or linking of multimedia advertisements 23, a payment area 24, and the an area to access “metrics” and statistical data regarding the ads placed 25.

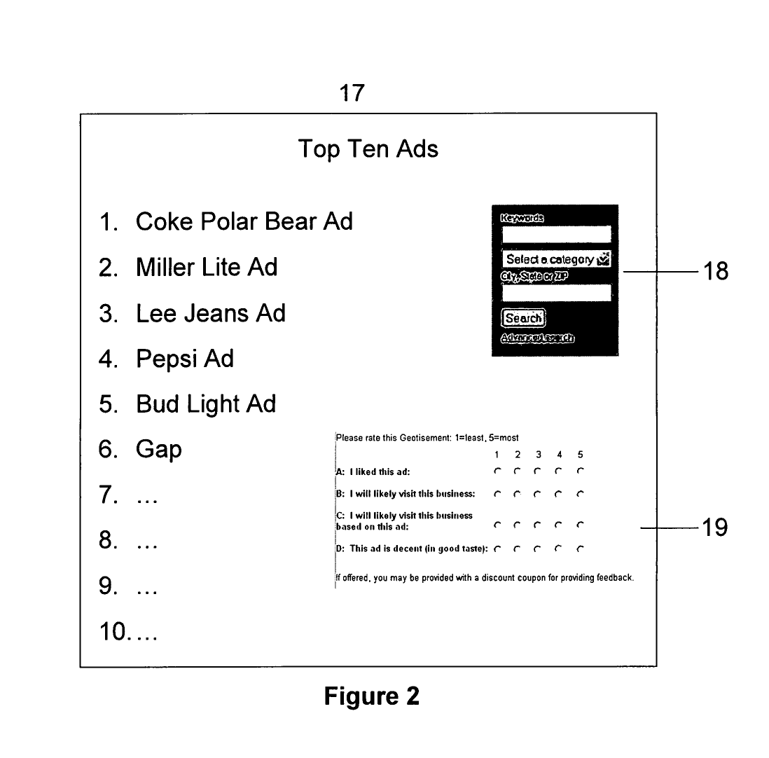

Referring to FIG. 2, the end user consumer is similarly presented with a series of user screens 17 which facilitate the access to selected online ads 18 and which provide the end user with the ability to view advertisements as well as to view and rate them 19.

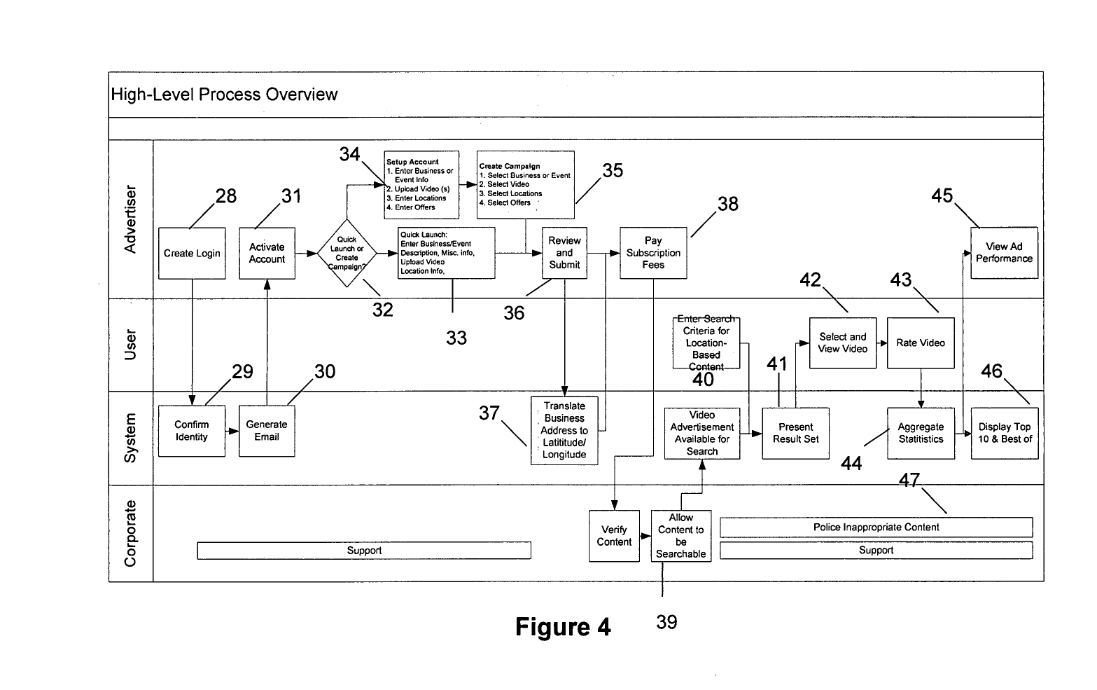

Referring to the diagram of FIG. 4, more specifically, the invention envisions a system by which an advertiser can create a login and account 20. The advertiser's identity is confirmed by the system 29 and an email is generated 30 by the system and forwarded to the advertiser to activate the account 31. The user selects 32 whether to perform a simplified upload referred to as a “quick launch” in which the advertiser enters business product/service or event descriptions, miscellaneous information, locations and uploads video 33 or performs a more complex operation of setting up an account 34 and creates a campaign 35. The advertiser then reviews and submits the information 36 and allows the business address to be translated to latitude/longitude by the system.

Referring further to FIG. 4, the invention envisions a system by which the more advanced advertiser can create an account by entering business product/service or event descriptions, miscellaneous information, special offers, locations and can upload video 34. The advertiser selects an advertisement to be associated with a business or event, associates the advertisement with one or more locations, and associate each location with the same or more than one special offer 35.

In one embodiment, the system can be set up as a pay model or subscription service 38. With the pay model, the advertiser receives a message from the system and is asked to pay a fee. The fee may be the combination of a flat fee, a fee based on the number of geographic locations to be associated with the advertisement, and the number of days the advertisement is to be made available to the public for searching and review. With the subscription pay model, the fee may be based on a daily or weekly subscription rate plus a flat listing fee.

After payment, the video advertisement is available for viewing by the end user 39. In one embodiment the content is reviewed by a third-party operator in order to prevent objectionable content from being made available to the end user consumer. The end user consumer can search for, or select 40 the video selection, which the system presents for viewing 41. The end user can view the video selection 42 and then rate the video 43. Aggregate statistics are generated 44 and put into the “Top 10” and “Best Of” directory for display on a webpage or website 46. This information is then able to be viewed for advertisement performance by the advertiser 45. The third party operator has the capability to police content and approve or reject submissions 47.

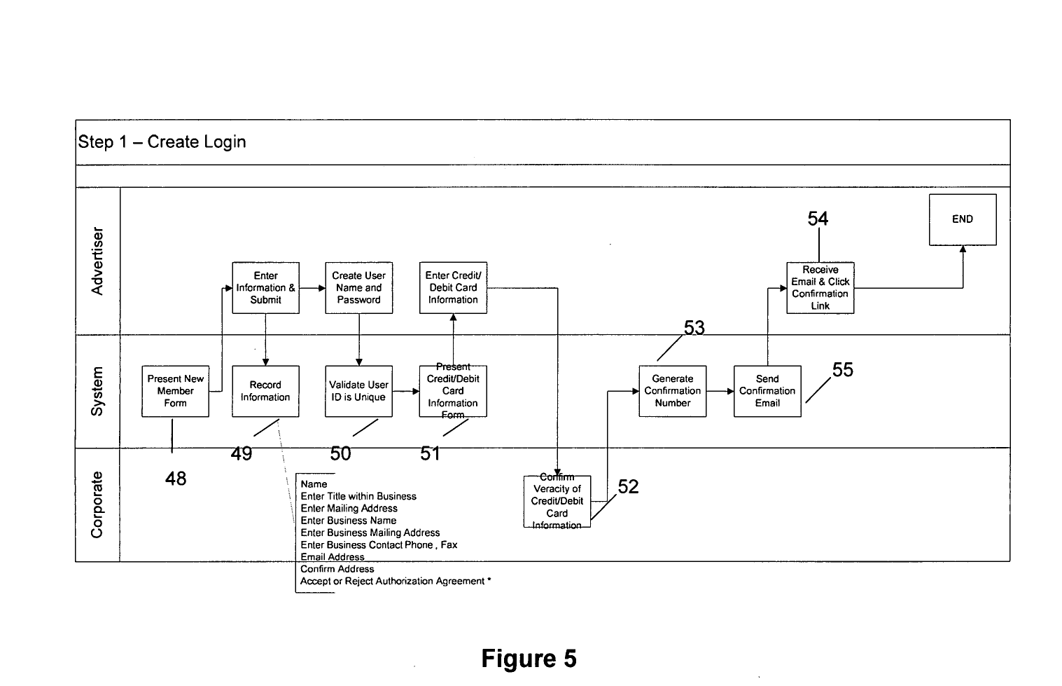

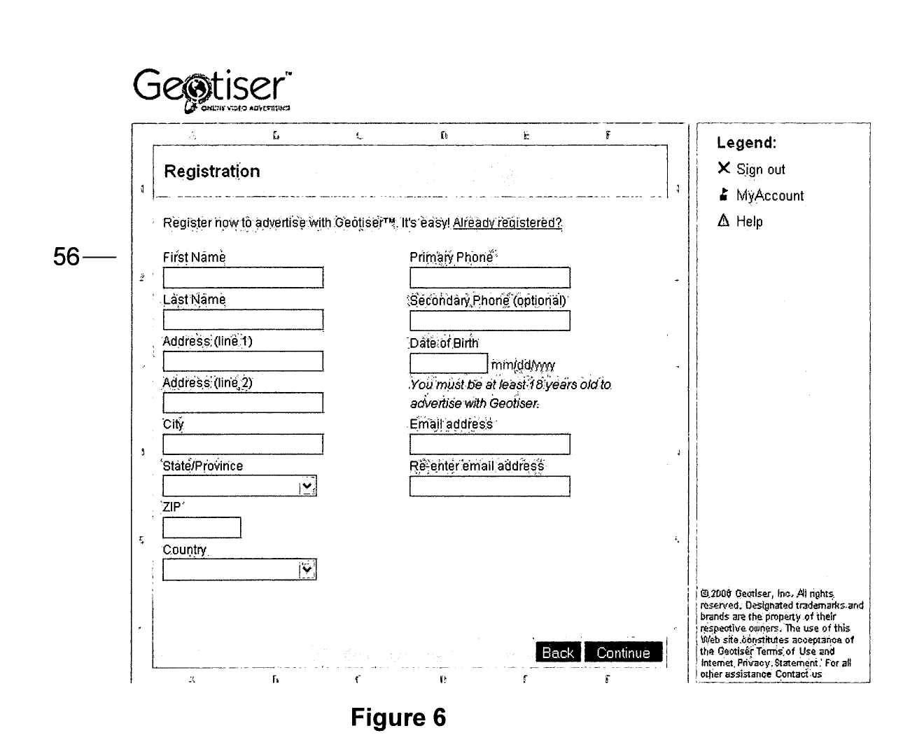

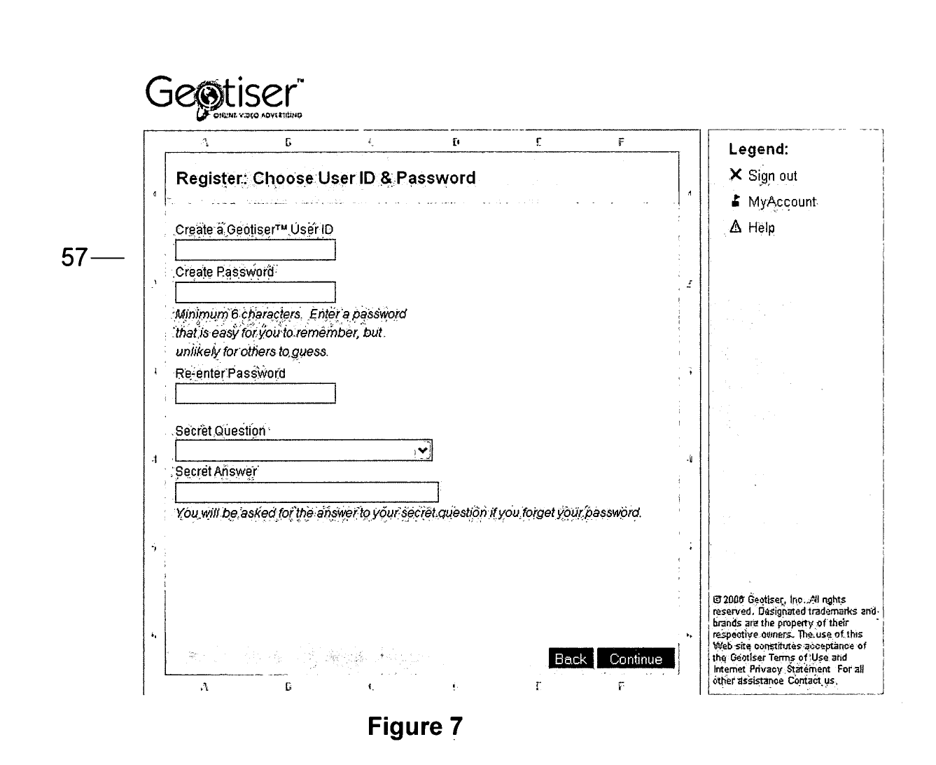

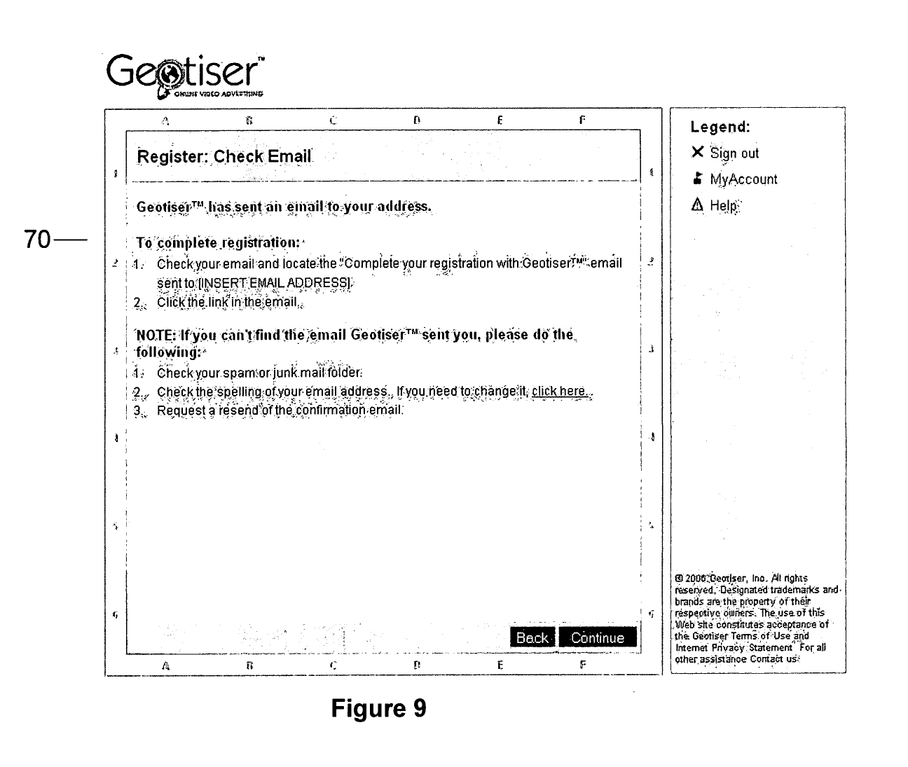

The operation of the invention from the advertiser's side is now described in greater detail. FIG. 5 illustrates a login process for the system. First, the system presents a new member form 48 on which the advertiser can enter information to the system for storage 49. FIG. 6 illustrates a form 56 on which the user submits registration information. The advertiser then creates a user name and password which is submitted to the system to validate that the user ID is unique 50. FIG. 7 illustrates a form 57 on which the user enters user ID and password information. The system may then request credit/debit card information 51 which the advertiser completes and sends back to the system. The system then sends the completed form to a third party business associated with the system to confirm and validate the credit card information 52. Once confirmed by the third party, the system generates a confirmation number 53 and sends an email with the confirmation to the advertiser 55. FIG. 9 depicts the notification form indicating that the email has been sent 70. Once the advertiser receives the email, the advertiser can click the confirmation link 54.

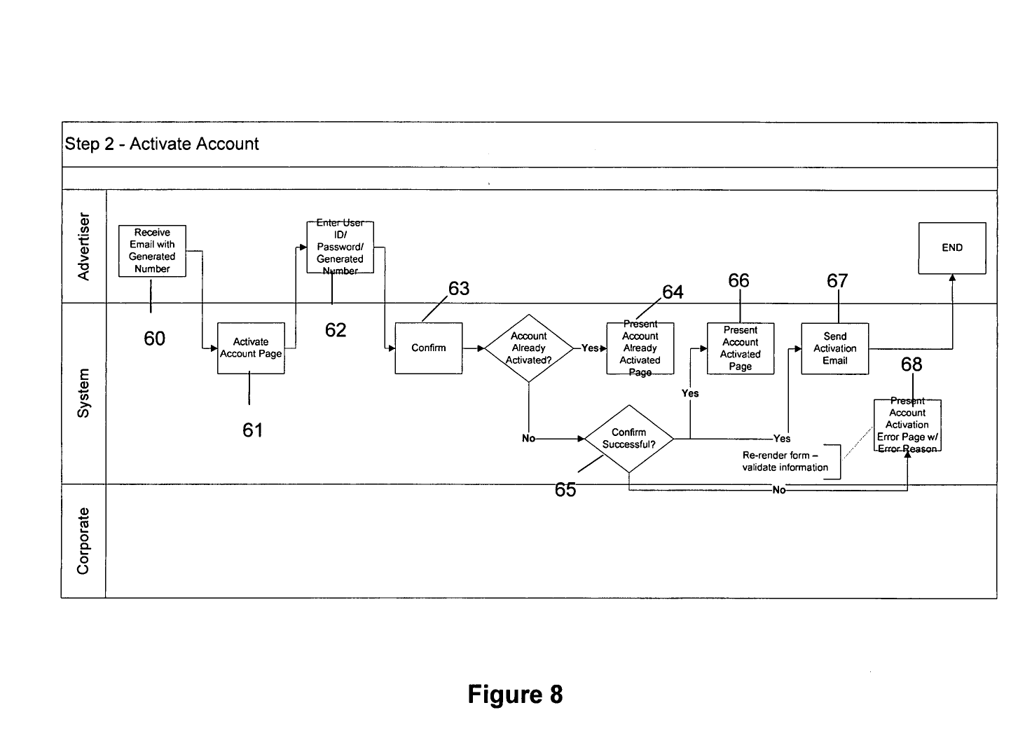

The next step, which is shown in FIG. 8, permits the advertiser to activate its account. Once the advertiser clicks on the email with the generated number 60, the system activates the account page 61 and the advertiser is able to enter a user ID, password and the system-generated confirmation number 62. The system then confirms the user ID, password and generated number to confirm if the account has been previously activated 63.

If previously activated, the system will forward to a present account already activated page 64. If the account has not been activated already, the system will confirm if the account was successful 65. If the account confirmation is not successful, the system will present the user with a re-render form to validate information and the system present an account activation error page with an error reason 68. If the account is able to be confirmed, the system will go to a present account activated page 66 and an activated account email 67 will be sent to the advertiser.

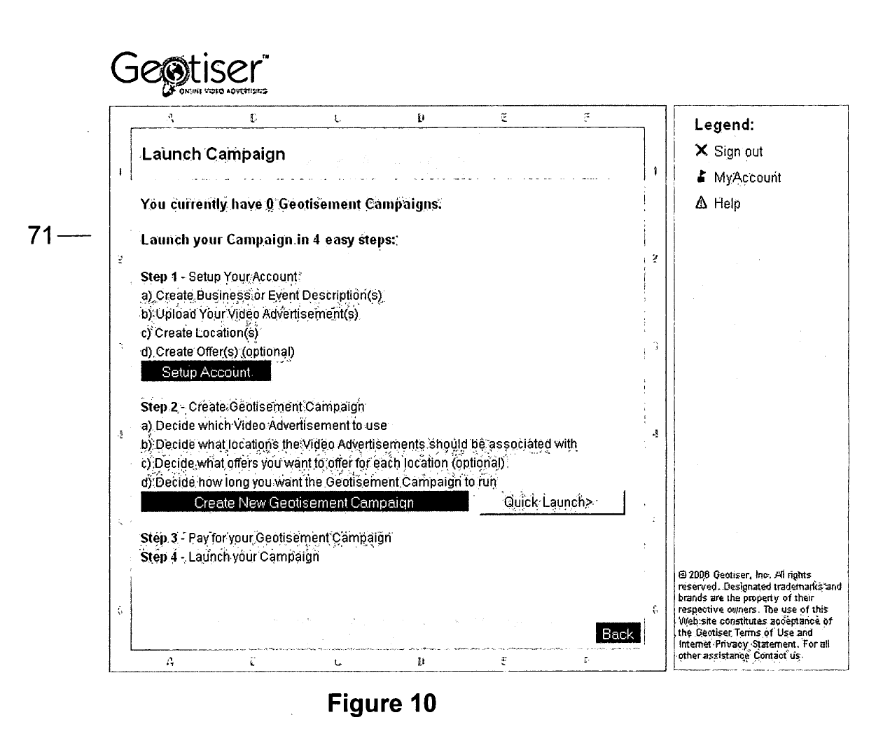

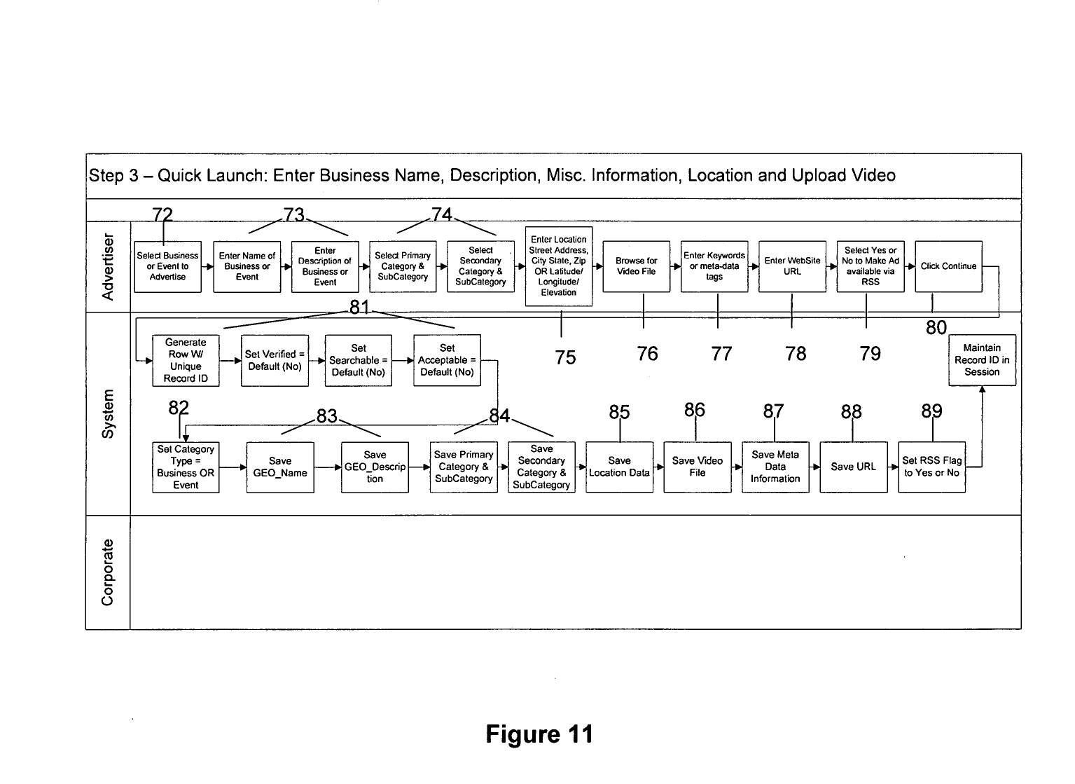

FIG. 10 depicts the user screen upon login 71 for the advertiser. As shown in FIG. 11, the advertiser can select a “quick launch” process in which the user selects a business or event to advertise 72. At this point, the advertiser will select the business, product or event to advertise, enter the name of the business, product or event and enter a description to the business or event 73. The advertiser then selects a primary and secondary category and subcategory 74 which will be used by the system for cataloging the advertisement for searching by end users.

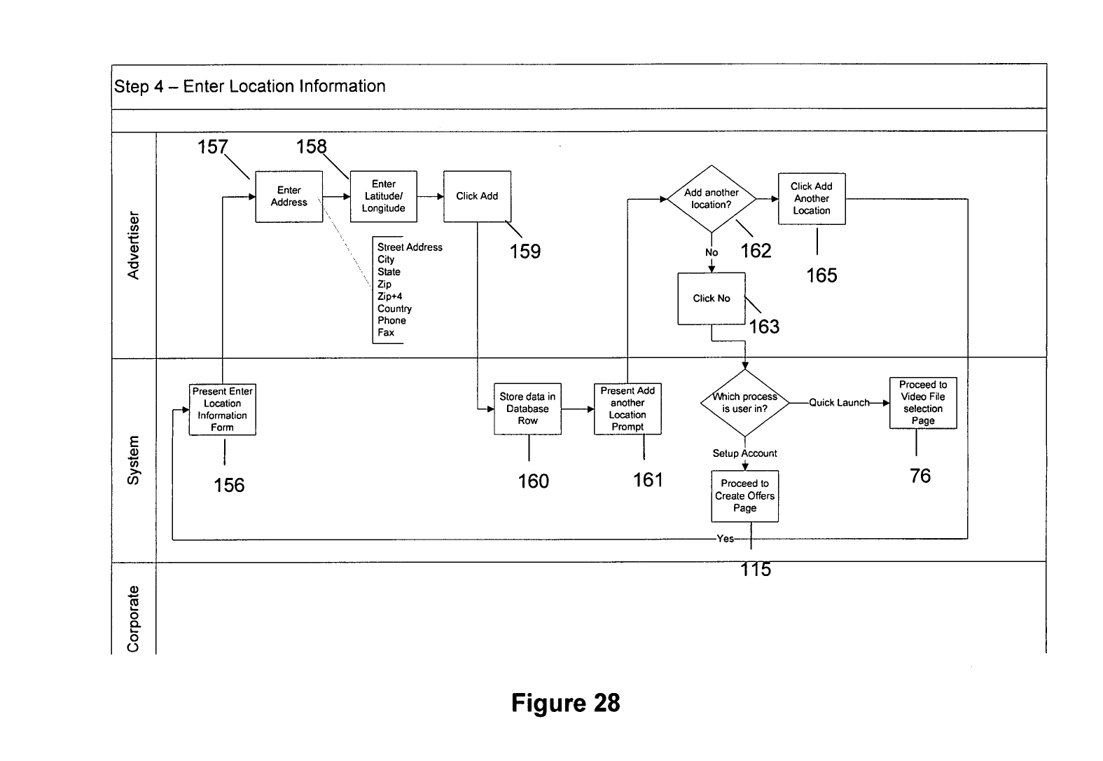

The advertiser then enters a street address or geographic location such as latitude, longitude and optionally elevation 75. FIG. 28 illustrates in detail the process by which a user adds locations to the system. The system presents an enter location information form 156 and the advertiser will enter its address 157. This information should include the advertiser's street name, city, state, zip code and four digit code, country, phone and fax. The user may also enter “longitude and latitude” information 158. The user may also enter an elevation. For example, three stores each on a different level of a shopping mall may have the same latitude and longitude, but may have different elevations. The advertiser would then click Add 159. The system will store the location data in a database row 160, and will then present a user selection form to the user requesting whether the user wants to add an additional location 161.

If the advertiser chooses to add an additional location 162, the advertiser would click Add another location 165 and the system would present the enter location information form 156. If the user does not want to add another location, the user clicks No 163 and the system proceeds to the next page. If the user is adding locations within the “quick launch” process the system presents the upload video file form 76. If the user is in the “setup account” process the system presents the create offer information form 115.

The user then browses for a video file in its local computer associated with the ad 76. The file may be stored as a number of file types, for example MPEG, RealMedia, WMV, AVI or MOV. The advertiser will further enter keywords for meta-data tags 77 and a website URL 78 that the advertiser desires to provide end users. For example, this may be a business website or official event website that the advertiser desires to advertise 75. The advertiser can then select “yes” or “no” to make the ad available via Real Simple Syndication, also known as “RSS” 79.

Once the advertiser clicks CONTINUE 80, the system will generate a table row with a unique record identifier and set the verified, searchable and acceptable default indicators to NO 81. The system will then store a category type for the business or event 82 and save a GEO name and a GEO description 83. The system will save the primary and secondary categories and subcategories 84, the number of locations 85, video file 86, meta data information 87, and URL 88. The system will further set the RSS flag to “yes” or “no” and maintain the record ID in the session 89.

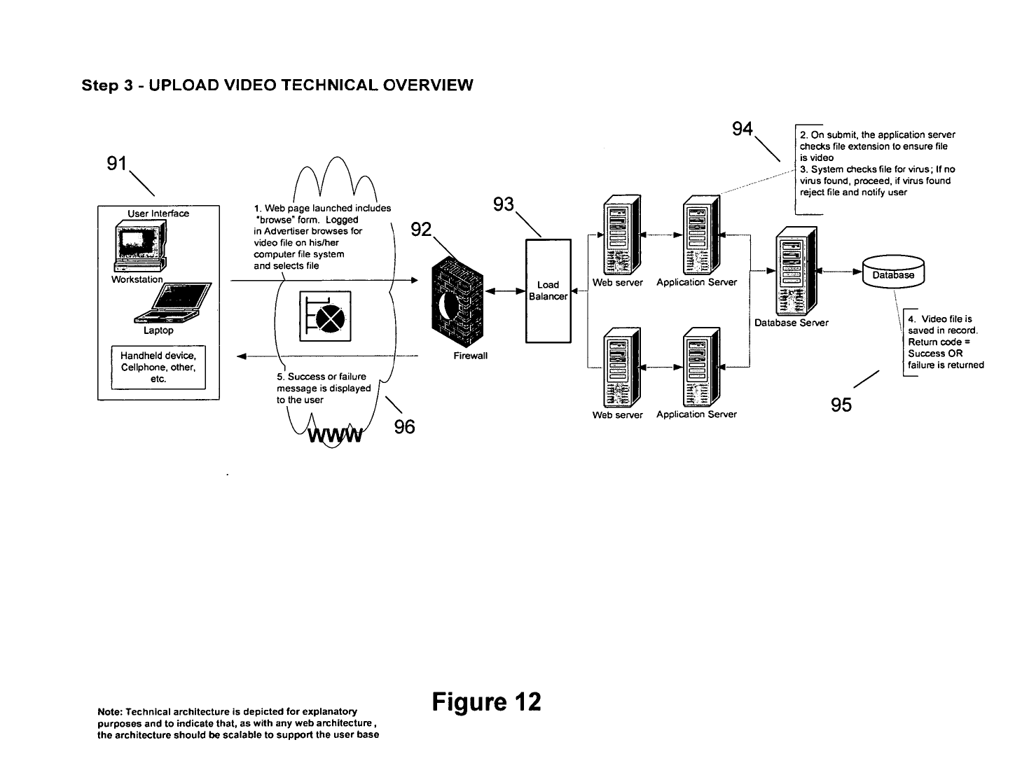

Referring to FIG. 12 a technical overview of the video upload process is shown in detail. As noted, the advertiser interface can comprise a wide variety of devices a computer workstation, laptop, cellular phone or handheld device 91. The web page launch includes a “browse for” function which enables the uploaded multimedia file to be reviewed. While logged in, the advertiser can therefore browse for a video file from its computer file system and select a file.

The central server facility 14 will have a firewall 92 to protect the central server system and files and a load balancer to balance user traffic 93. Once the advertiser submits a multimedia file, the server checks for the file extension to ensure the file is a video. The system then checks the file for any viruses. If no virus is found, the system proceeds. If a virus is found, the file is rejected and the user is notified 94. The video file is then saved as a record with a return code of success or failure 95. The system uses the return code to display a success or failure message to the user 96.

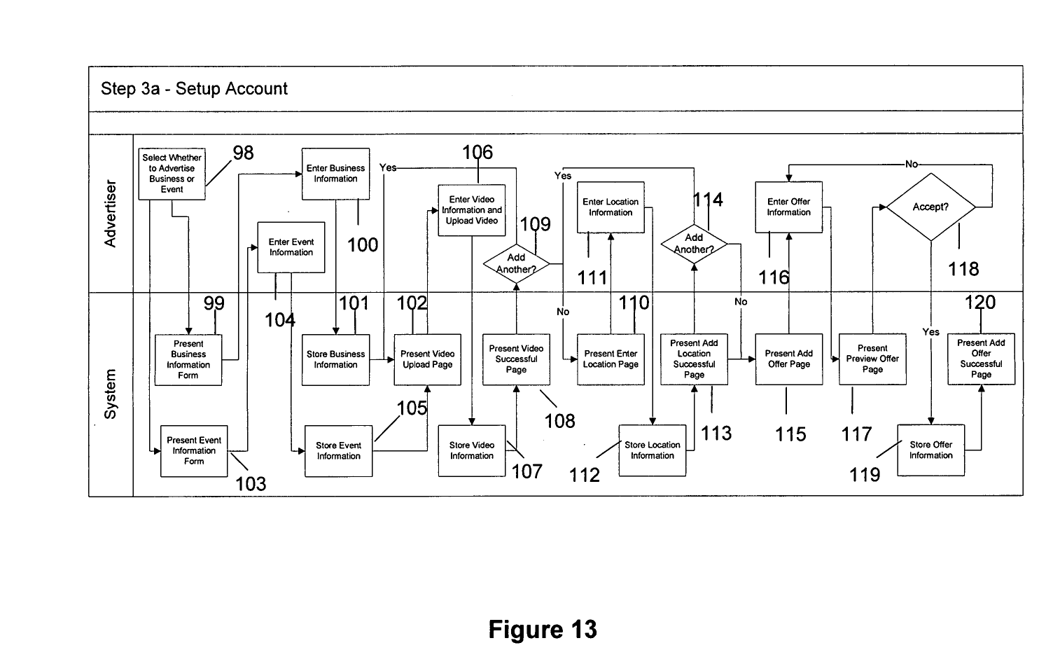

The system to setup an account from which an advertiser can launch an advertising campaign is described in FIG. 13. The user selects whether to advertise a business or event 98. If the user selects to advertise a business, the system presents a form 99 on which the user can enter business information 100. Once the information is submitted by the user, the system will store the information 101 and present a video upload page 102.

If the advertiser selects to advertise an event, the system presents a form 103 on which the advertiser can enter business information 104. Once the event information is submitted by the user, the system will store the information 105 and present a video upload form 102. The advertiser can enter description information for the video, browse for the video file and submit the video upload to the system 106. The system will store the video file 107 and present a page to the user indicating that the file has been uploaded successfully 107. The system will present the user with the option to upload an additional video file 109. If the advertiser elects to upload another video file, the system will present a video upload form 102.

If the advertiser does not elect to upload another video file, the system will present a form in which the user can enter location information as either street address or latitude, longitude and optionally elevation 110. The advertiser enters the location information 111 and upon submission the system stores the location information 112. If successful, the system presents a page indicating to the advertiser that the information was successfully uploaded 113, and prompts the advertiser whether the user wants to enter another location 114. If the advertiser elects to upload another location, the system presents the enter location information form 110.

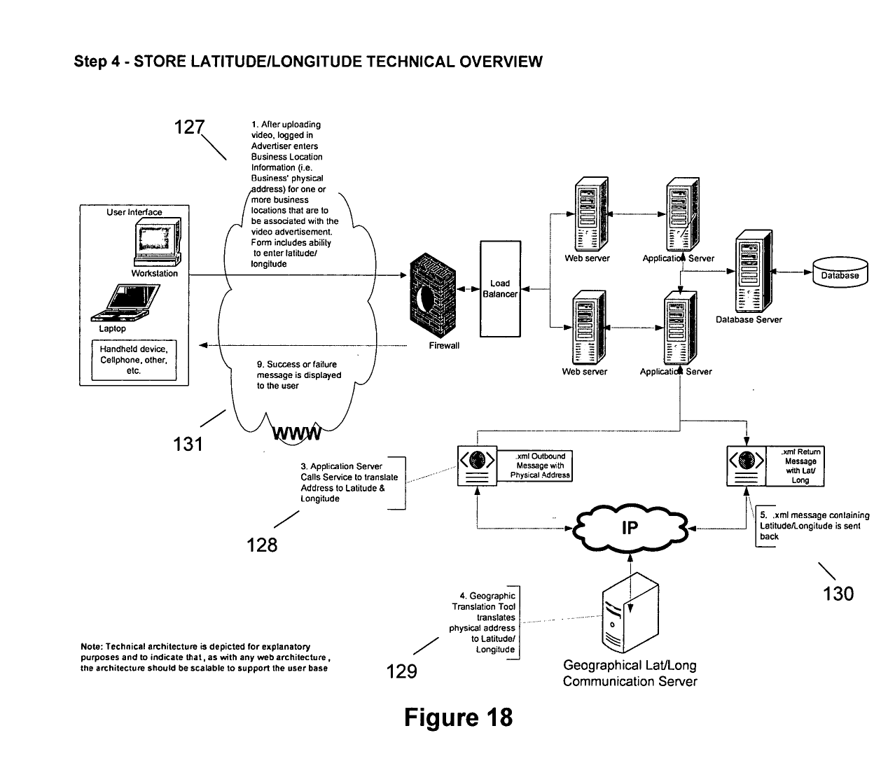

FIG. 18 illustrates the process by which advertiser's latitude and longitude is stored. After uploading the video, the logged in advertiser enters relevant business location information, for example, the business' physical address, for one or more business locations that are to be associated with the video advertisement 127. The form provides the advertiser with the ability to enter latitude, longitude and elevation information. The application server calls a mapping service, geocoding service or Geographic Translation tool to translate the address into a latitude and longitude 128.

A geographic translation tool 129 then translates the physical address to latitude and longitude. In one embodiment, an .xml message containing the latitude/longitude is then sent back to the communication server and the .xml message with the physical address is sent to the application server 130. A success or failure message is then displayed to the advertiser 131.

Referring again to FIG. 13, if the advertiser does not elect to upload another location, the system presents a form in which a user can enter information to provide a discount or special offer 115. If the user does not want to provide an offer, the user can skip this step 134. If the user skips the step, the system presents a completion page indicating that account setup is complete.

If the advertiser want to provide an offer, the advertiser uses the enter offer information form 115 to select either percentage or full amount and a currency, enter a description of the discounted services or goods, browse for and upload a barcode, browse for and upload a company image and expiration date. After submitting the information the system presents an offer preview page 117 in which the offer is shown as it will appear on the screen to the end user consumer. If the advertiser accepts the information as it appears in the preview 118, the user clicks accept and the system stores the information 119. If the submission of offer information is successful, the system presents an add offer successful page 120. If the advertiser does not accept the preview information, the system will return the advertiser to the enter offer information page 116.

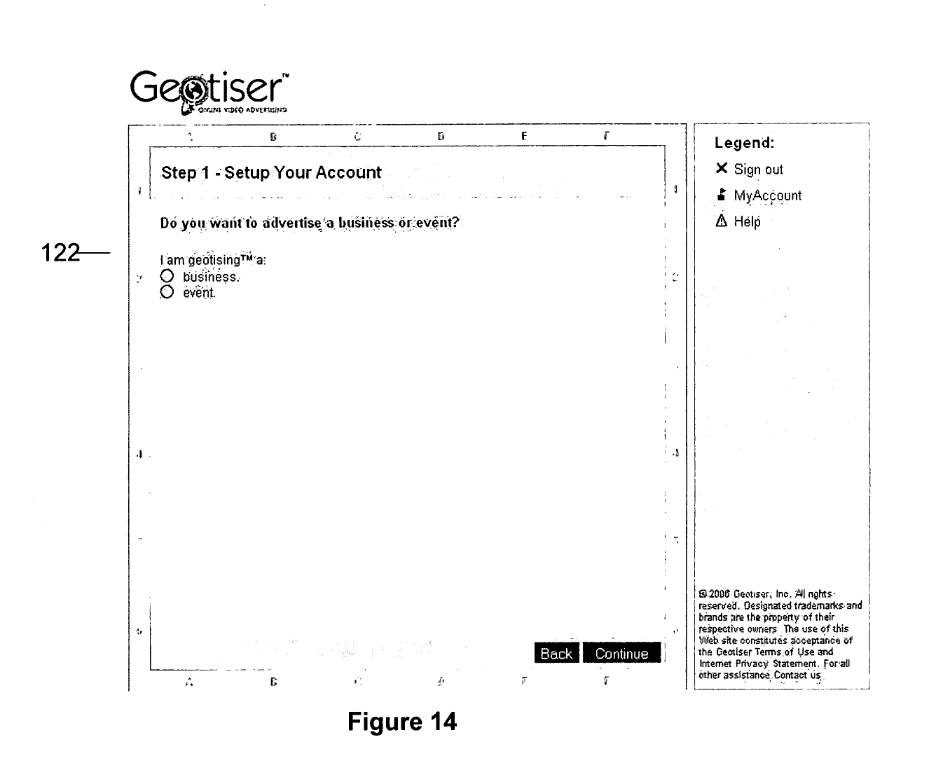

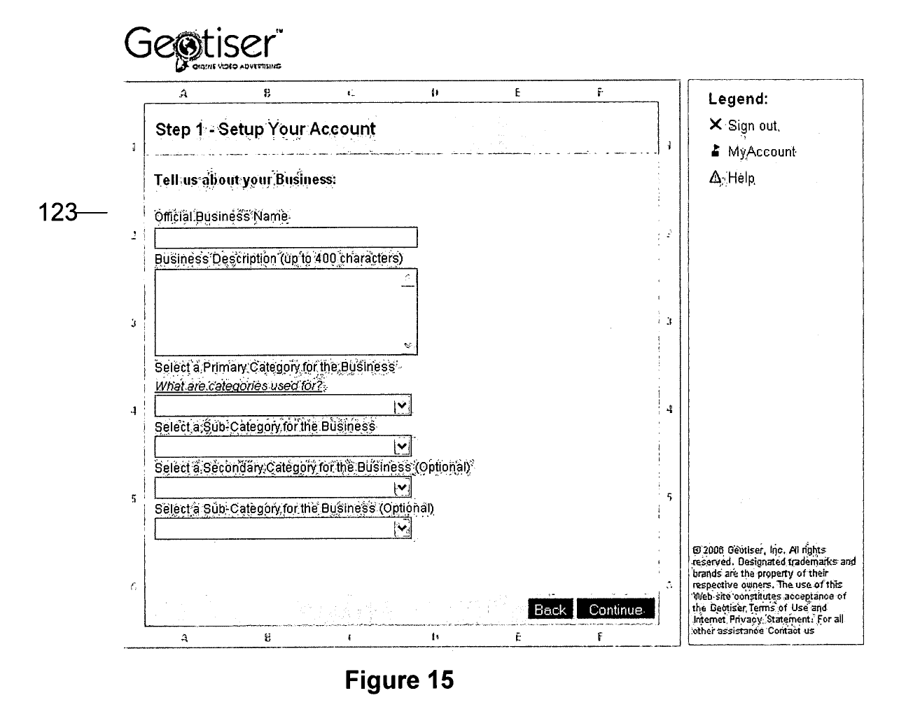

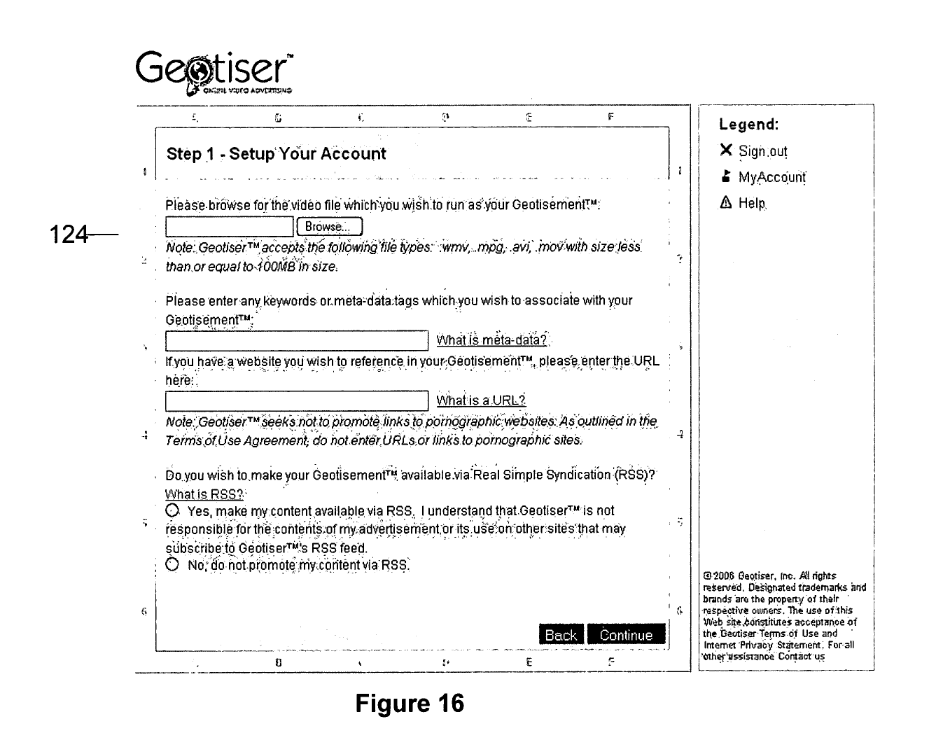

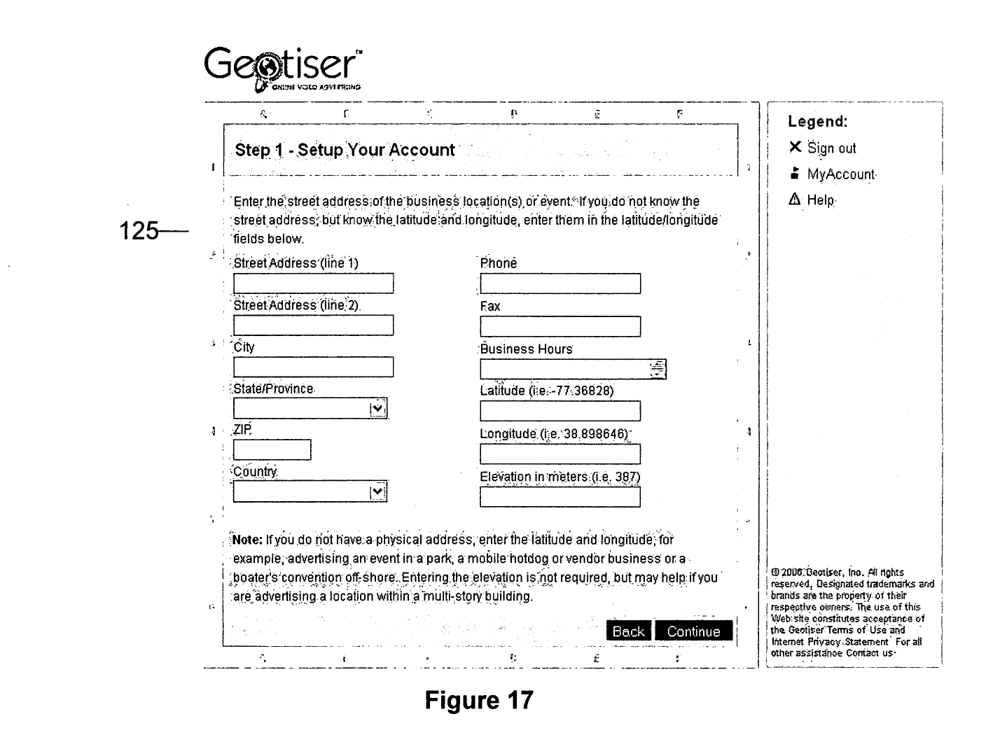

FIG. 14 depicts the form in which the advertiser selects whether to advertise a business or event 122. FIG. 15 depicts the form 123 in which the advertiser enters business information for storage in the system. FIG. 16 illustrates the form 124 in which the advertiser submits the video file and related information for storage in the system. FIG. 17 depicts the form 125 in which the advertiser submits location information for storage in the system.

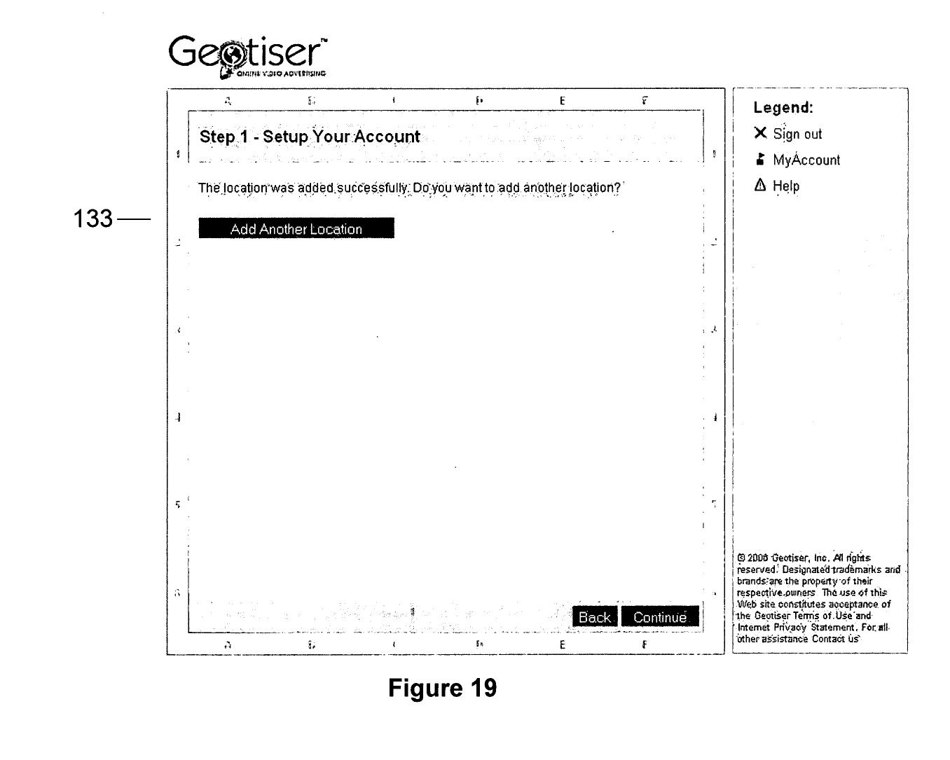

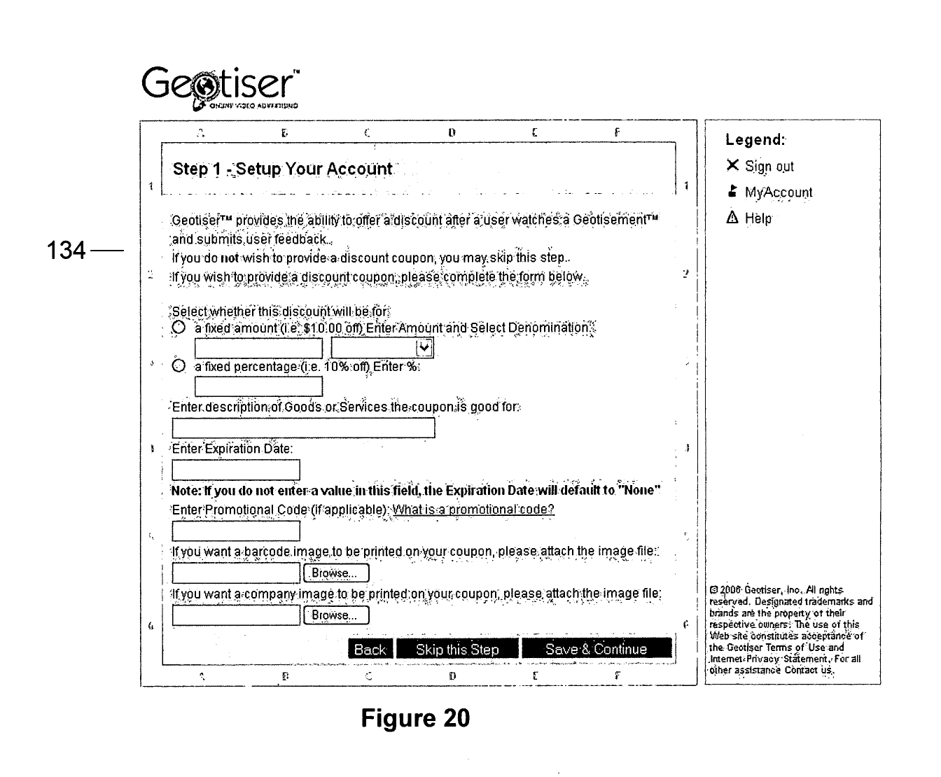

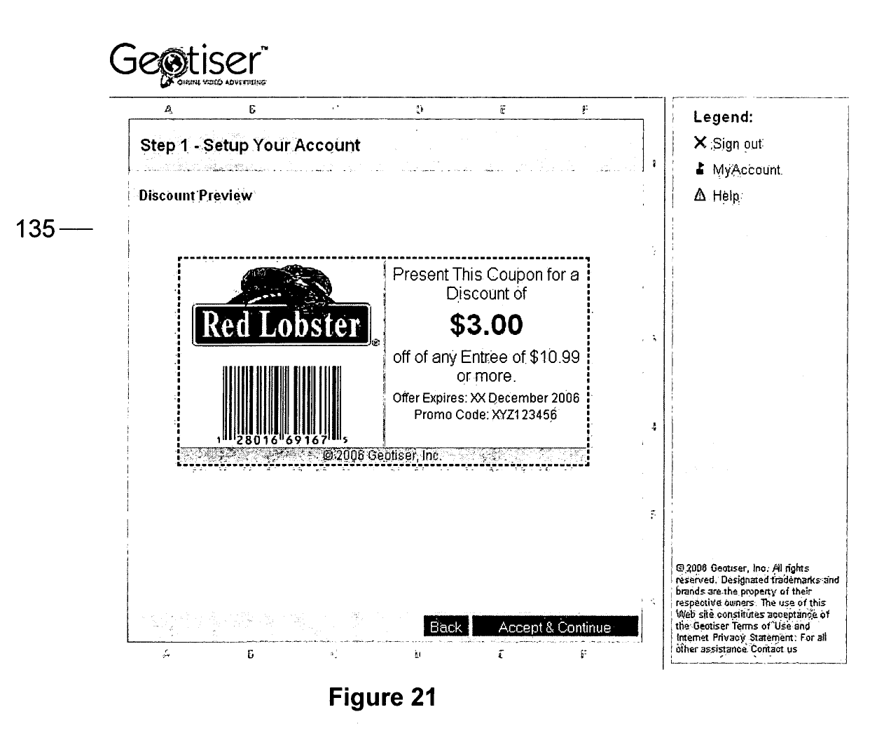

FIG. 19 depicts the form 133 by which the advertiser elects whether or not to add another location 114. FIG. 20 illustrates the form 134 in which the advertiser elects whether to skip the add offer step or to enter offer information 115. FIG. 21 illustrates the preview discount offer page 135 on which the advertiser can accept the offer as it appears in the preview 118 or go back to modify the information 116.

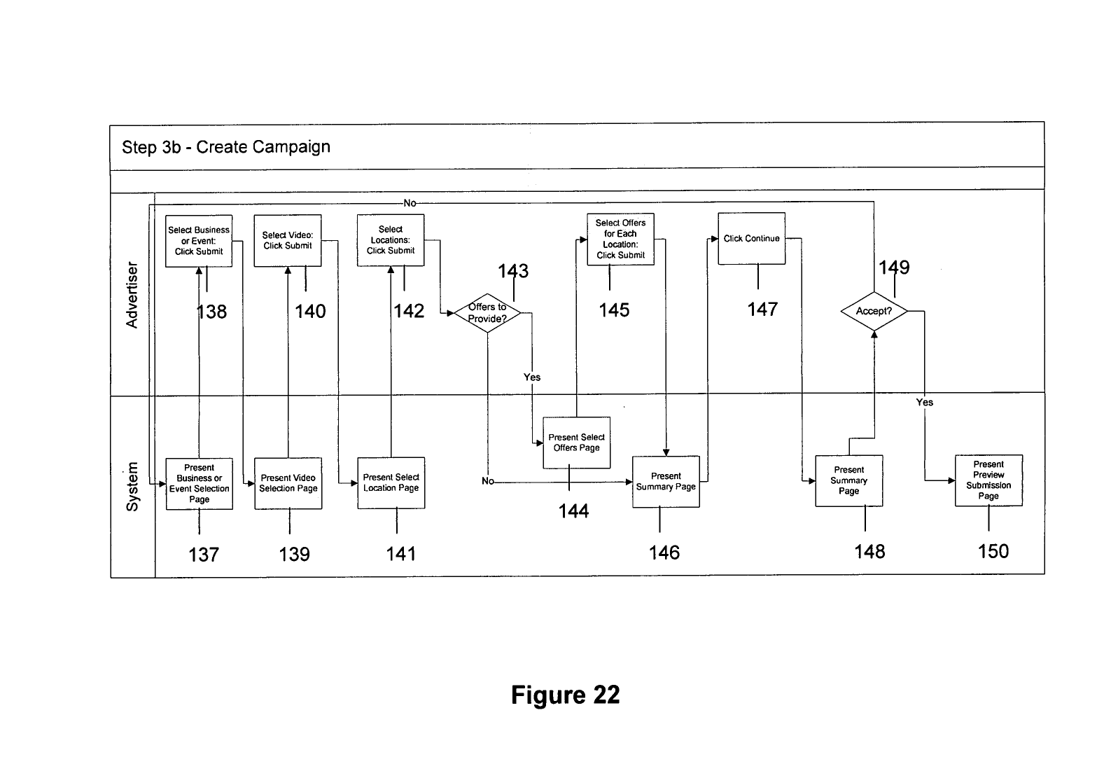

FIG. 22 describes the process for creating an advertising campaign with the present invention for the advertiser who has setup account information in the system. The system presents a selection form for the advertiser to select a business or event to advertise 137. The advertiser selects a business or event from the drop-down list 138 and clicks submit. The system presents a video selection page on which the user can select a video to associate with the business or event and click submit 140. The system presents a select location page 141 and the advertiser selects one or more checkboxes of locations submitted to the system to associate with the advertisement and clicks submit 142. If there are offers associated with the advertiser account 143, the system displays the association of business or event to video to location(s) and presents a page on which the user can select an offer to present for each location 144. The offer can be the same for all locations, or the user can select a different offer for each location. The advertiser may select not to present an offer to the end user consumer for one, any or all of the locations. If there are no offers associated with the user account 143, the system presents a summary page 146.

The advertiser clicks continue on the summary page 147, and the system presents a summary page of the user selections 148. If the advertiser does not accept the information on the summary page, the system returns the advertiser to the select business or event page 137. If the advertiser accepts the information on the summary page 149, the system presents the preview submission page 150.

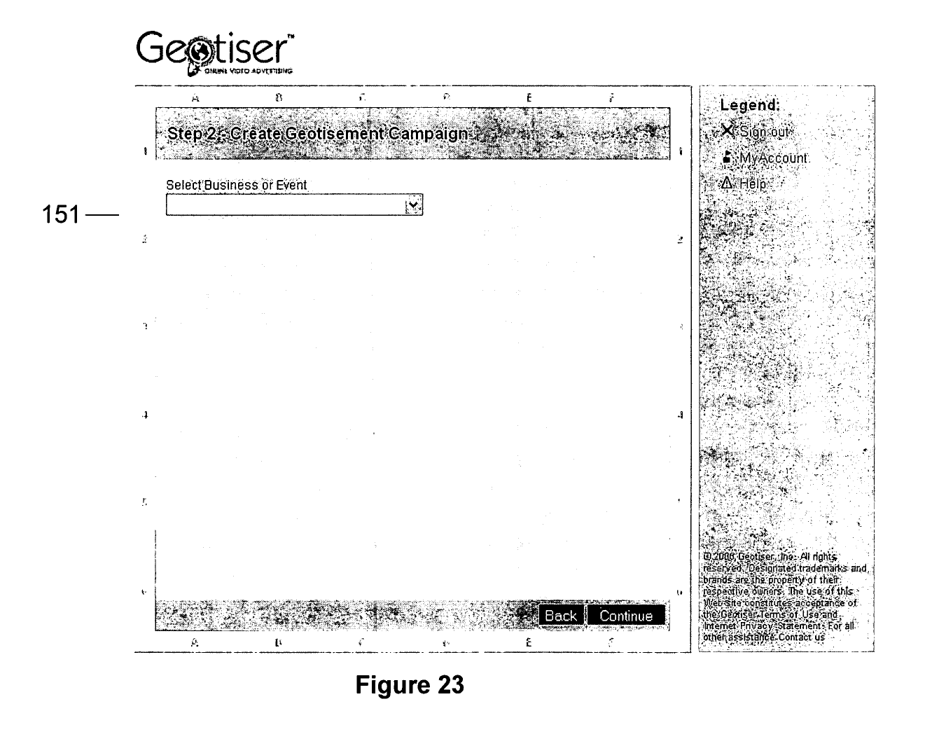

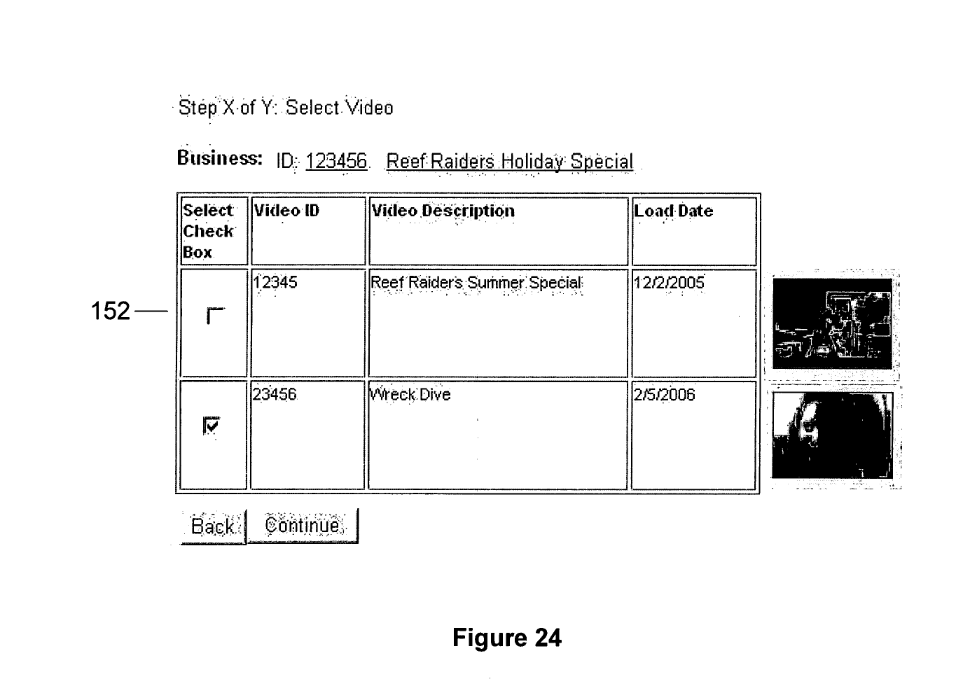

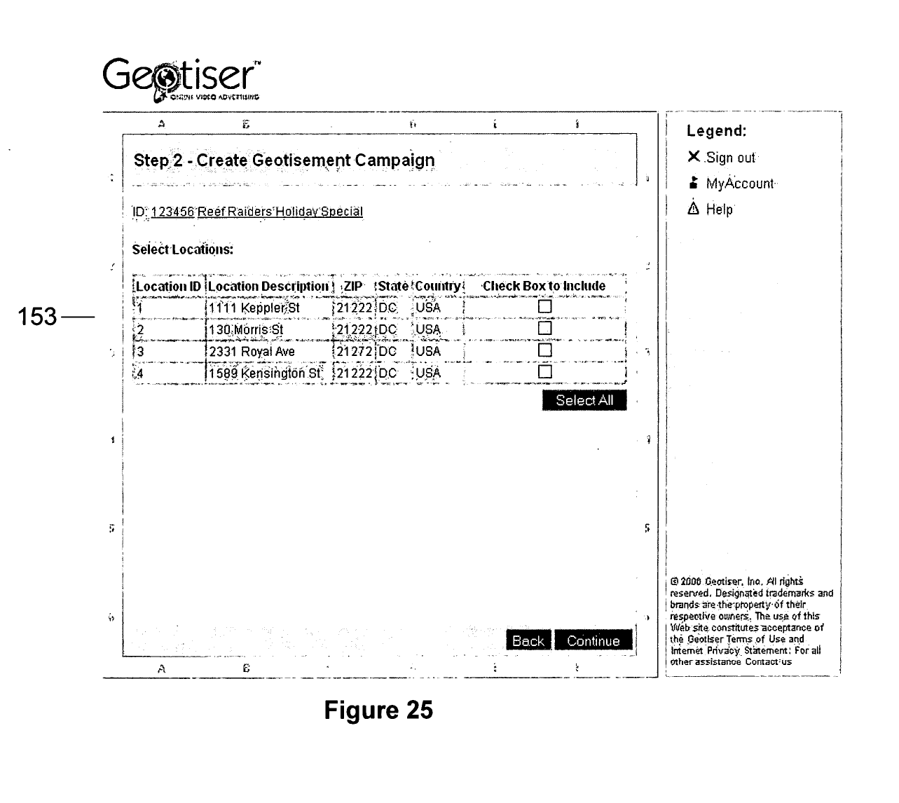

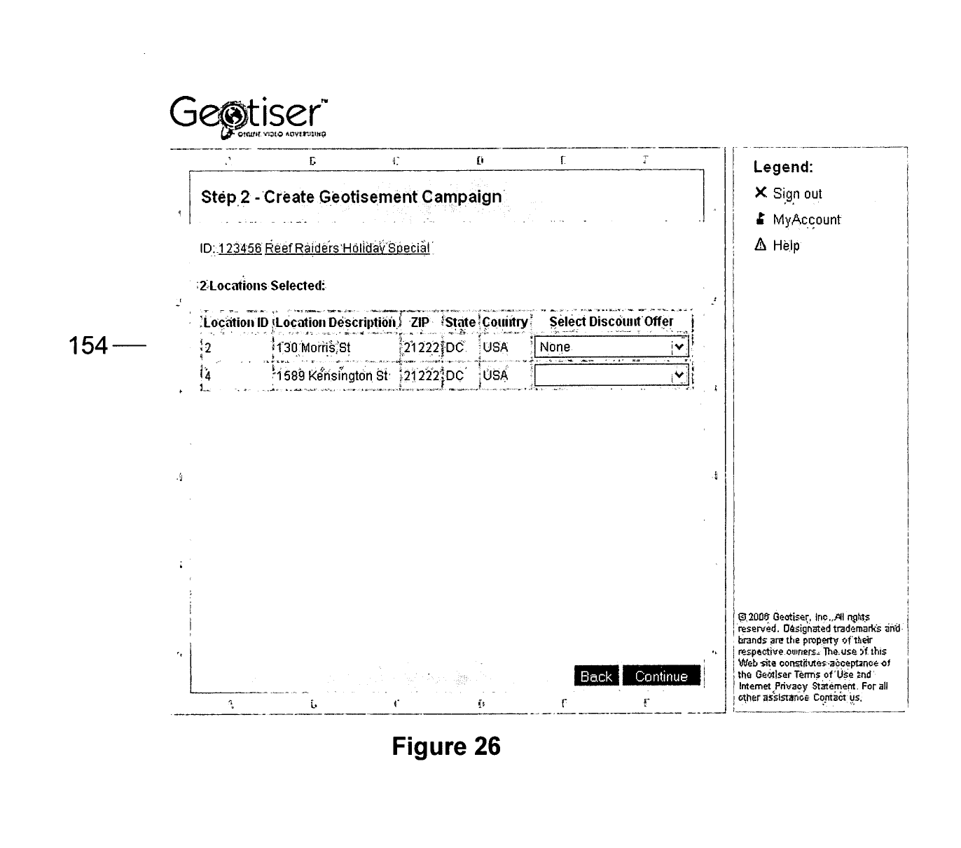

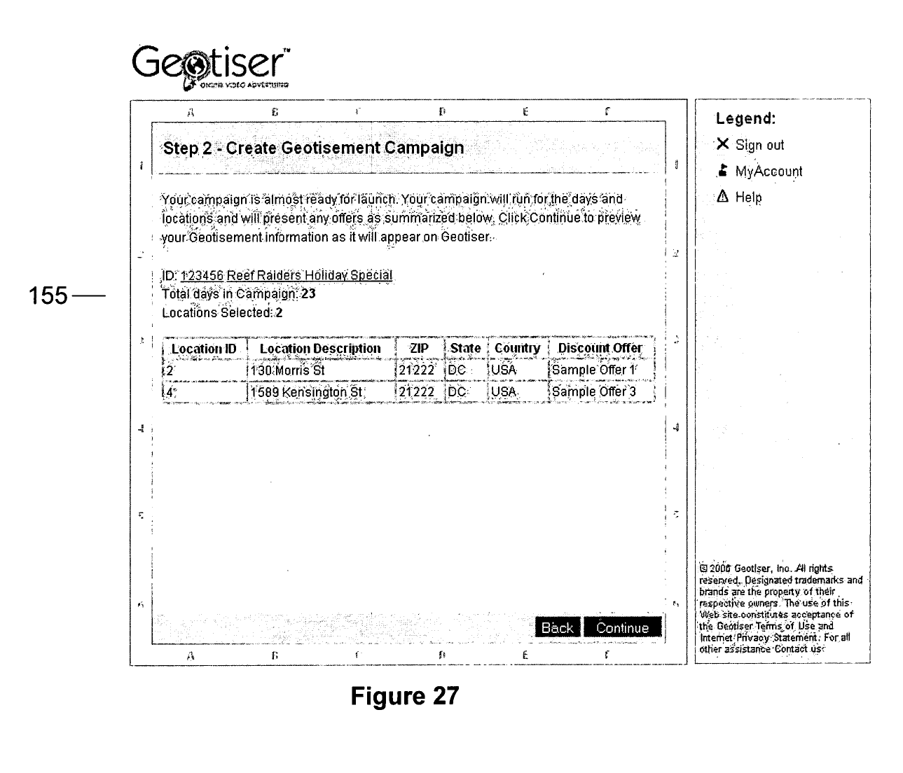

FIG. 23 depicts the advertiser interface 151 to select the business or event from a drop-down list populated by the businesses and/or events associated with the advertiser account. FIG. 24 illustrates the user interface 152 for the user to select a video to associate with the business or event advertisement. FIG. 25 depicts a sample user interface 153 on which the advertiser selects the locations to associate with the advertisement. In one embodiment of the present invention the user interface 153 also includes the latitude, longitude and elevation. FIG. 26 depicts a user interface 154 on which the advertiser makes selections from a drop-down box populated by the offers associated with the advertiser account to associate an offer to a specific location. FIG. 27 depicts a system-rendered summary page 155 which summarizes the advertiser selections.

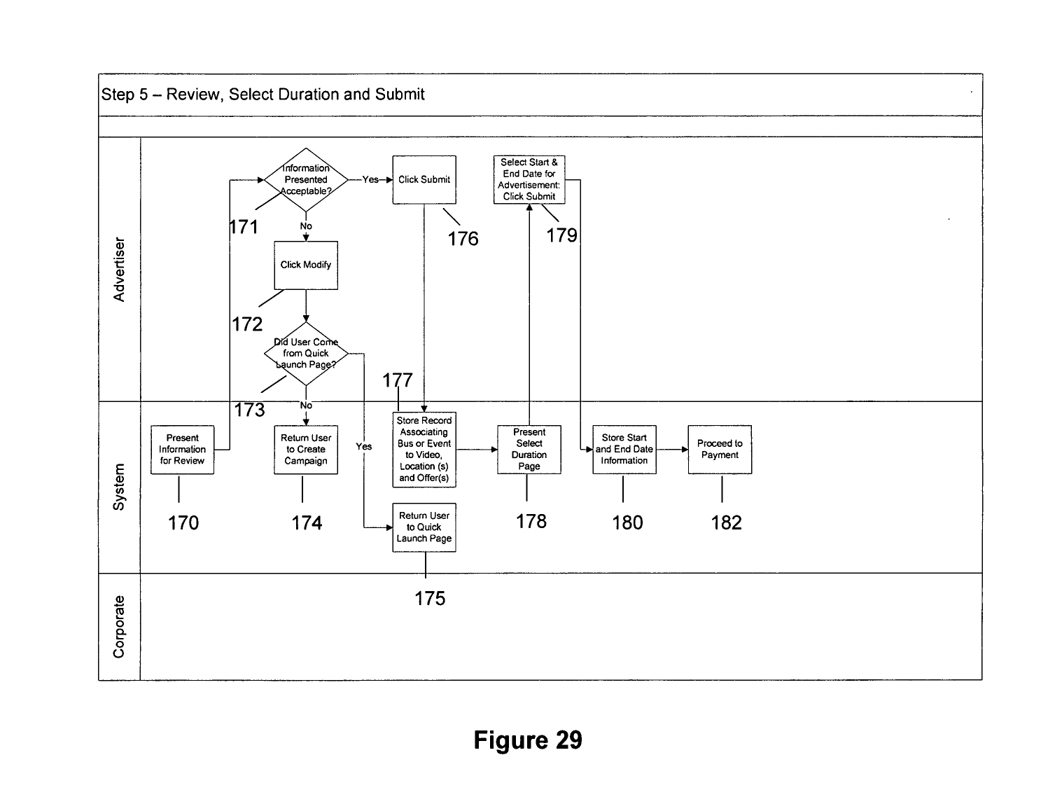

As shown in FIG. 29, the system then presents the submitted information to the advertiser for final review 170. If the information presented is accurate and acceptable 171, the advertiser will click “submit” 176. The system will then store the database record associating the business or event to the video file, location(s) and offer(s). The system will then present a select duration page 178. The advertiser selects a start and end date for the advertisement and clicks submit 179. In one embodiment of the present invention the advertiser may select a start date and time, and an end date and time for the advertisement. The system will store the start and end date 180 and will present the user with the system to accept payment.

If the information is not accurate or acceptable to the advertiser, the advertiser may click modify 172 to revise the entered business name, description and attached video file page. If the advertiser came from the quick launch page 33 (FIG. 11) the system will return the user to the quick launch page 33. If the advertiser did not come from the quick launch page, the advertiser will be returned to the create campaign select business or event page 122.

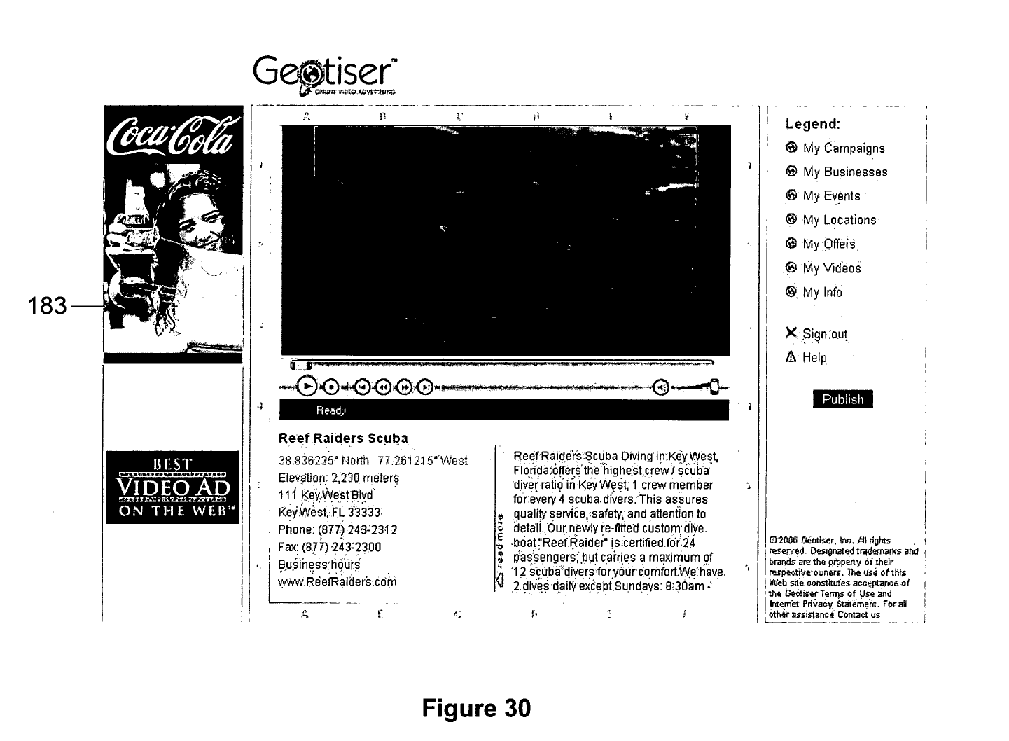

FIG. 30 illustrates the advertisement preview page 183 displaying the information as the system will present the information to the end user. The page includes advertising blocks that may be populated with advertisement information or once the advertisement is available to the public for viewing, if the advertisement achieves a “Top 10” or “Best of” ranking, with a special logo to highlight the achievement.

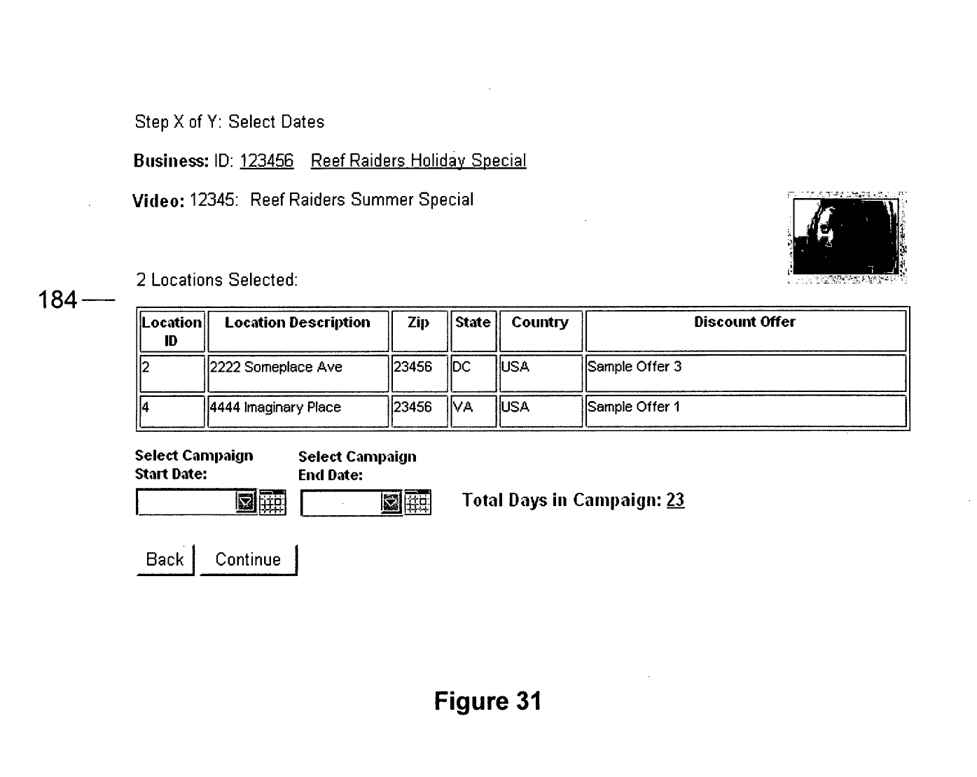

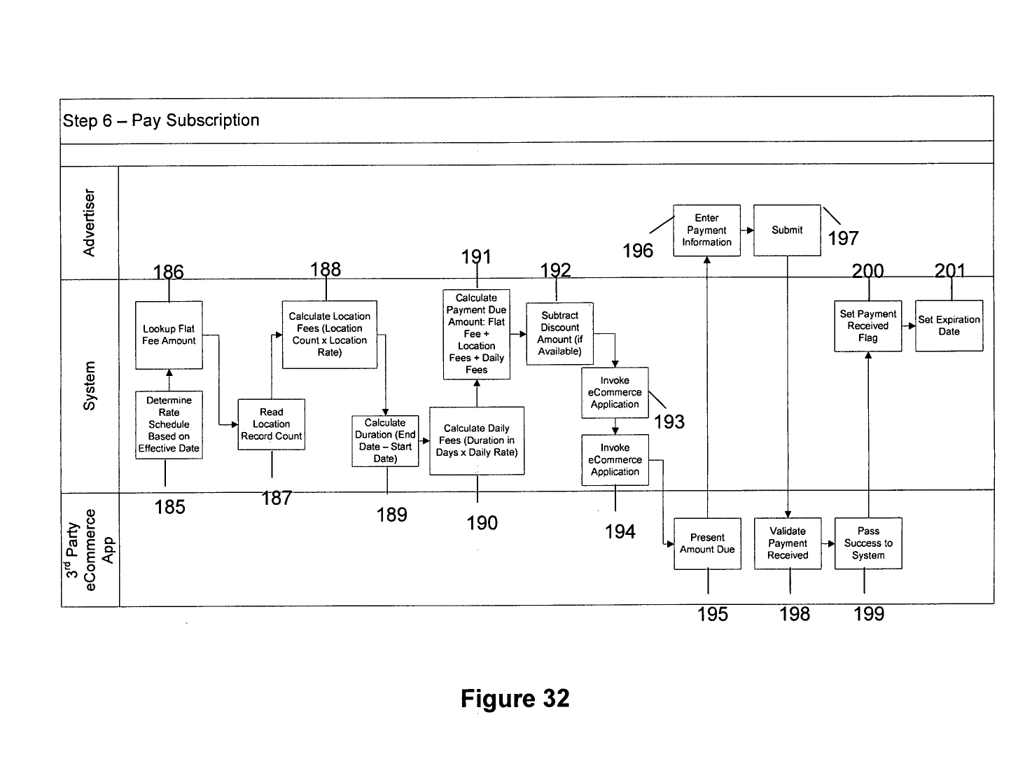

FIG. 31 illustrates the summary page 184 on which the advertiser selects the start and end date for the advertising campaign. As noted above and as shown in FIG. 32, the invention is preferably shown in the context of a subscription or pay service in which the advertiser will pay the operator. The service calculates a total payment amount due 193. To calculate the total payment amount due, the system will determine a rate schedule to use based on the effective date 185. The system will lookup a flat fee amount 186 and will determine the number of locations to be advertised 187. The system will calculate location fees 188 based on the location count multiplied by the location rate based on the rate schedule 185. The system will calculate the duration in days that the advertisement is to be viewable to the public by subtracting the start date from the end date 189. The system calculates daily fees 190 by multiplying the duration 189 by the daily effective rate from the rate table 185. The system calculates the payment amount due by adding the flat fee amount 186 plus the location fees 188 and the daily fees 190. The system will subtract any available discount amounts associated with the user account 192 to derive the total amount payment due 193.

The system will invoke an eCommerce application 194. The third party operator application 11 then presents an amount due from the advertiser 195, who enters its payment information 196 and submits it back in the eCommerce Application 197. The third party operator 11 then validates that the payment was received 198 and passed to the system 199. The system will then set the payment received flag 200 and set an expiration date 201 based on the end date.

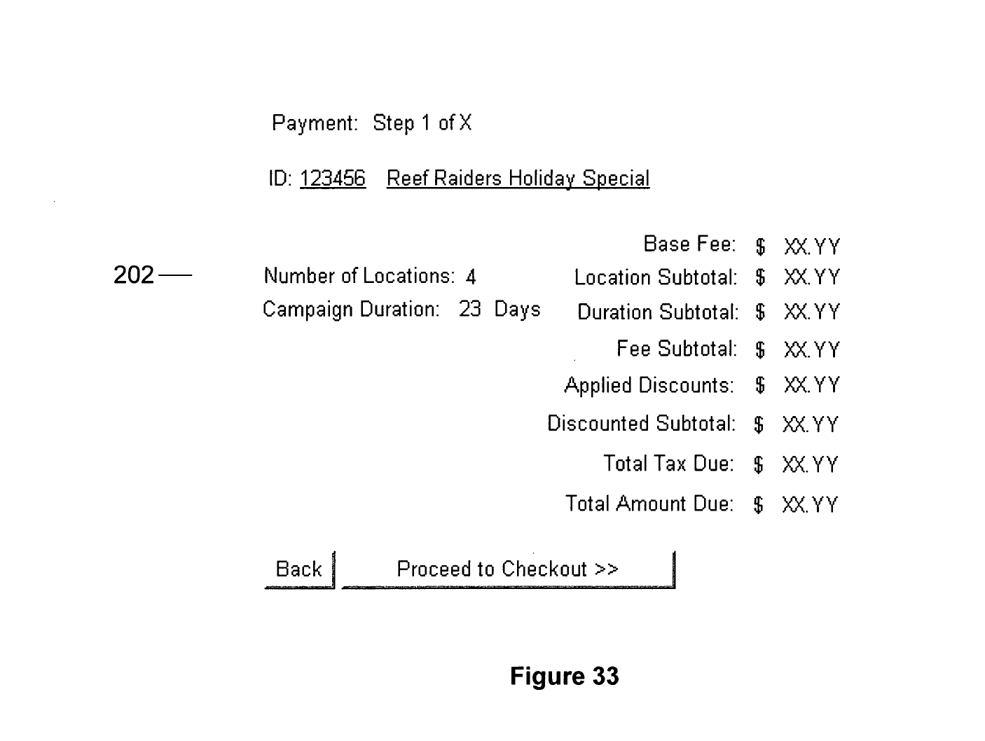

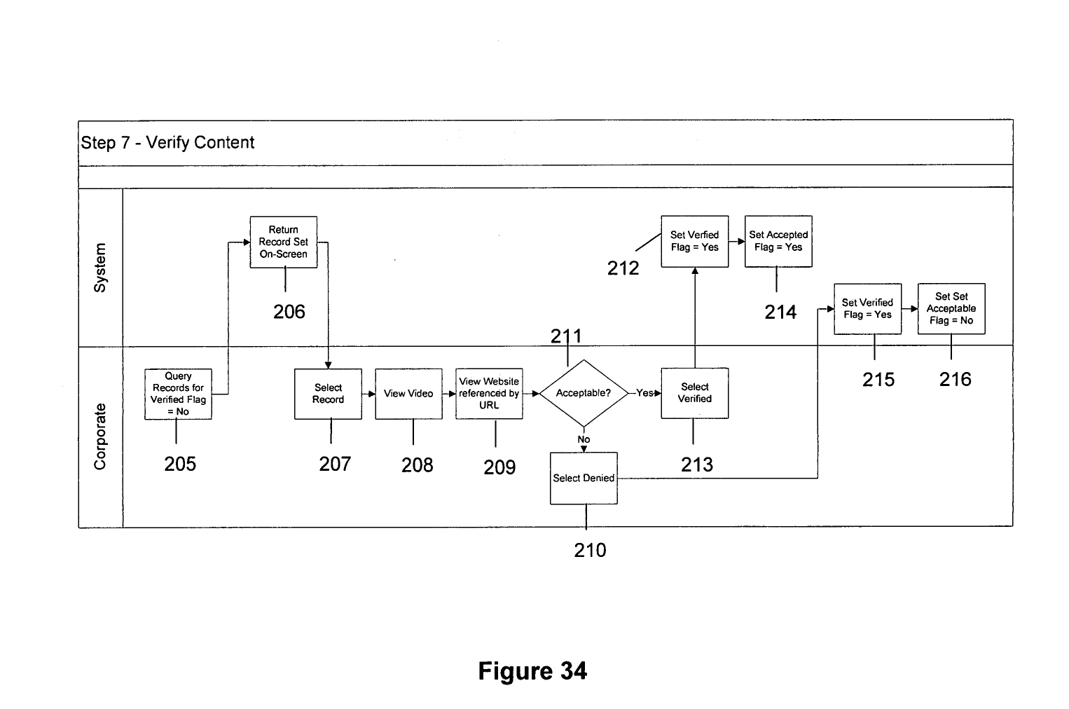

FIG. 33 illustrates the payment due summary page 202 that would be presented to the user for payment 195. FIG. 34 illustrates how the content is verified. The third party operator 11 will submit a query for those records where the verified flag is No to the system 205, which with then present the return record set on the third party operator user screen 206. The operator will then select a record 207, review the information, view the video 208 and view the website referenced by the URL 209. If the selection is not acceptable 211, the operator will deny the selection 210 and the system will set the verified flag as Yes 215 and the accepted flag as No 216. If the selection is acceptable 211, the user will select Verified 213 and the system will set a verified flag for that record to Yes 212 and accepted flags for that record to Yes 214.

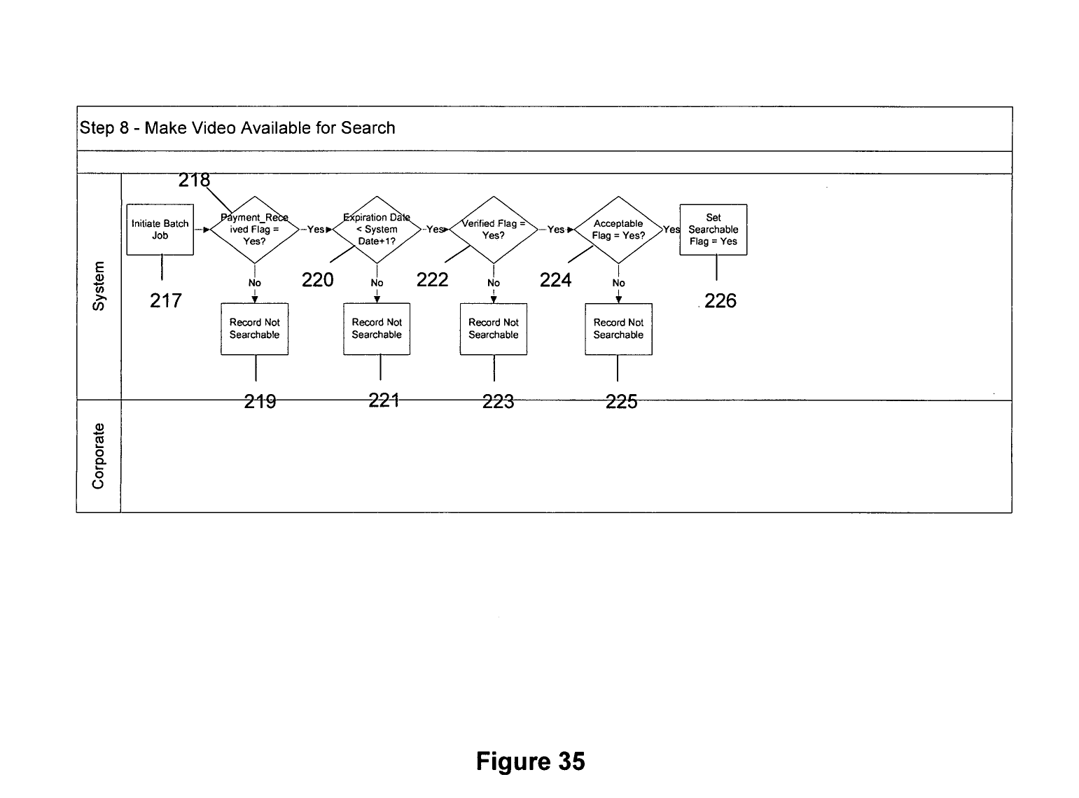

FIG. 35 illustrates the process by which the system makes a video available for search by an end user consumer 12. The system will initiate a batch process 217 that will make records searchable where the payment was received 218, the expiration date has not yet been reached 220 and the verified and accepted flags are yes 222, 224. As long as all the above variables are good, the system will set the searchable flag to yes 226. If any of these variables are no, the system will mark the record as not searchable 219, 221, 223, 225.

The operation of the invention from the end user's standpoint through to approval by the third party operator is now described. As noted, the end user may access the system via a webpage or website such as “TopTenAds.com”

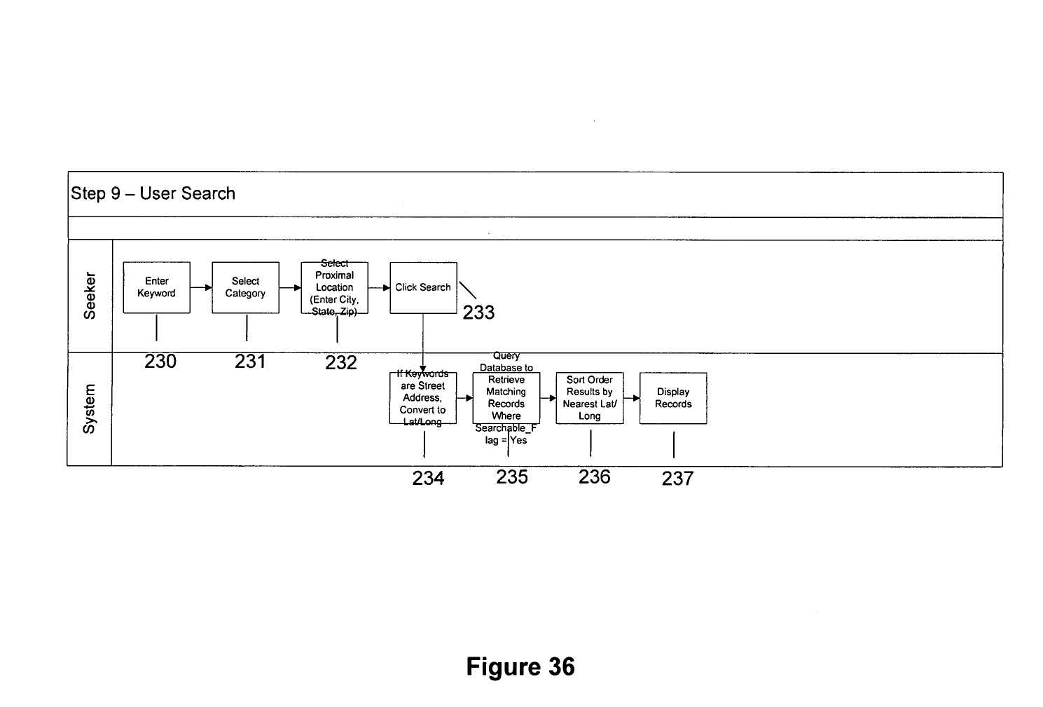

In FIG. 36, the end user 12 is able to initiate a search. The use begins by entering a keyword 230 and category 231. The end user 12 then selects a proximal location by entering city, state and/or zip code 232 and clicks Search 233. The system will convert street address to latitude and longitude 234. The database query will retrieve matching records where the searchable flag has been set to Yes 235. The system will then sort the order results by the nearest latitude and longitude corresponding to the user search criteria 236 and display the records 237. In one embodiment, the system will provide the capability to sort the results by name.

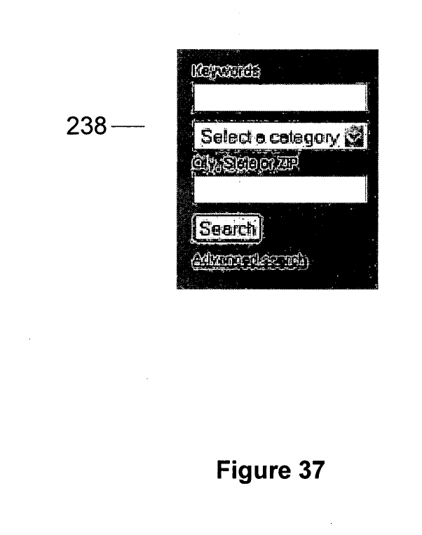

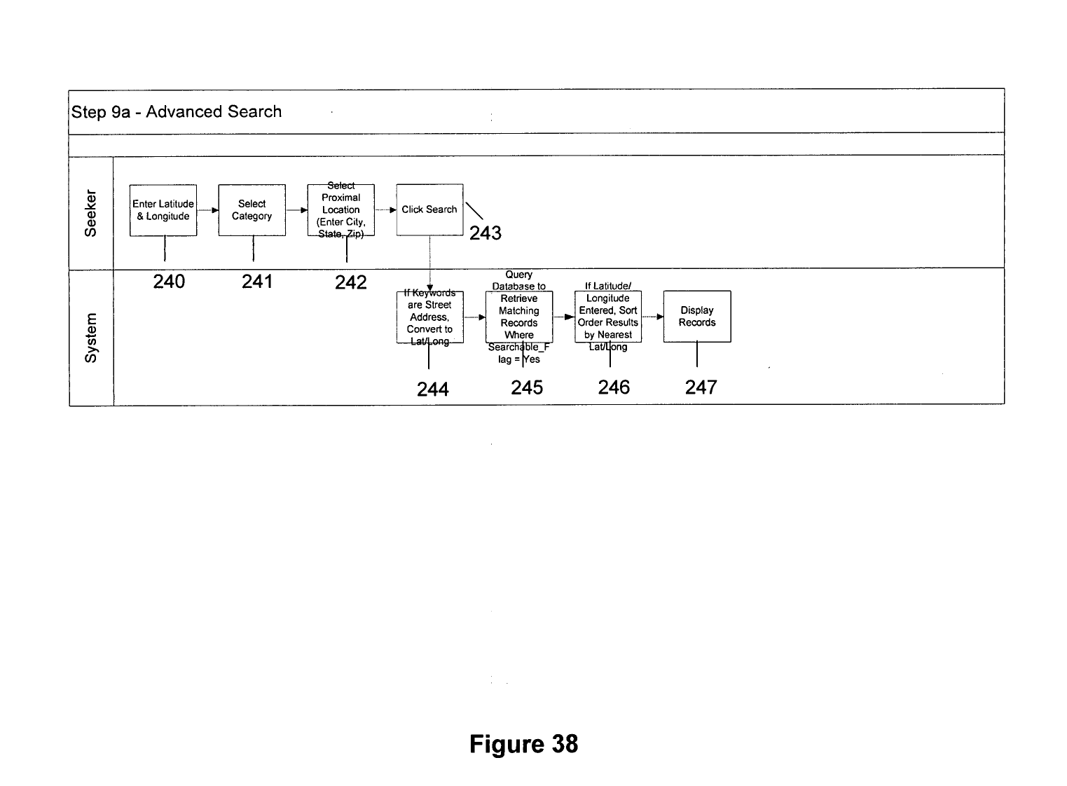

FIG. 37 illustrates an end user search form 238 in which the end user can enter keywords, select a category, and/or city, state or zipcode information. In FIG. 38, an end user can perform an advanced search by entering the latitude and longitude 240 and selecting a product or service category 241. The user would the select a proximal location by entering the city, state and/or zip code 242 before clicking search 243. If the keywords were a street address, the system would convert it to latitude and longitude 244 and conduct a database query to retrieve matching records where the searchable flag is Yes 245. If the latitude and longitude are entered, the order results will be sorted by the nearest latitude and longitude to the latitude and longitude entered by the user 246 and the system will display the records 247.

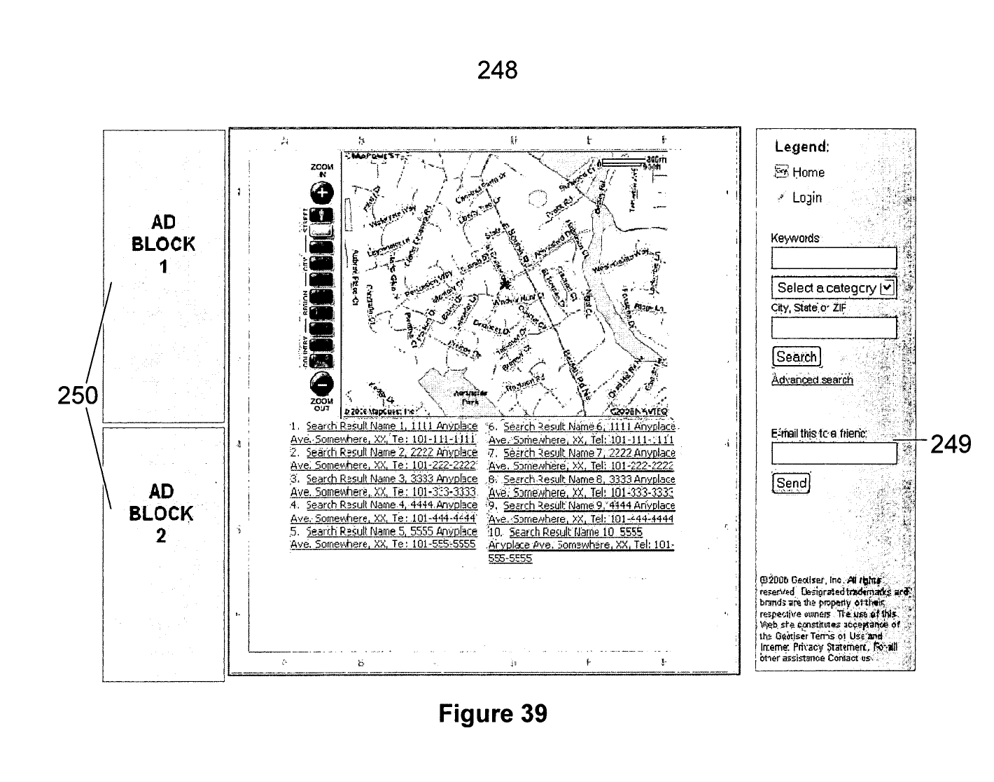

FIG. 39 illustrates the system presentation page 248 of the search results in which the search results are displayed on a map or geographical representation as well as listed below the map. The end user can email search results to a friend(s) by entering an email address into the email a friend form 249. Upon clicking send, the system will invoke the users default email capability on their PC, laptop or other device and an email with the url from the search result page will be contained in the body of the email and sent to the user. The advertising blocks 250 contain advertisements which the third party operator controls through a system control panel by associating the static advertising content in advertisement blocks 250 to an advertising category, sub-category or business. Each time that a search result within a category or sub-category is displayed the associated advertising block 250 displays the associated static advertisement content.

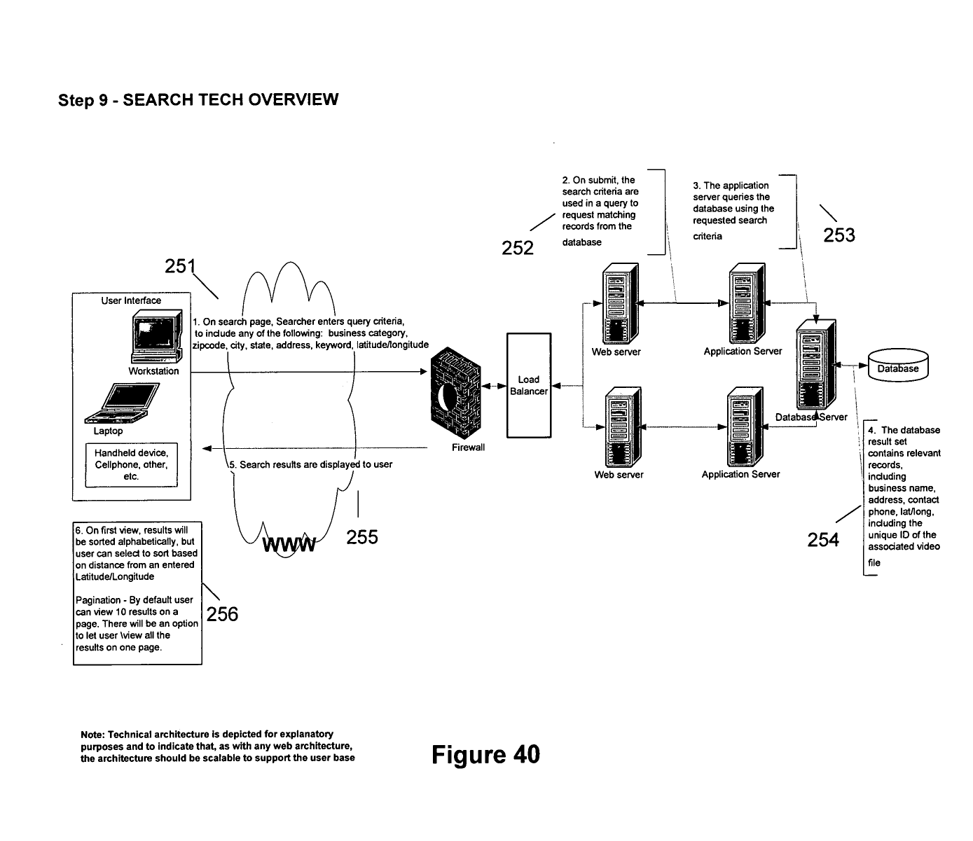

FIG. 40 illustrates an overview of the end user search technology. On the search page, the end user searcher enters a query to include information such as business category, zip code, city, state, address, keyword, or latitude and longitude 251. Upon submission, the search criteria are used in a query to request matching records from the database 252. The application server queries the database using the requested search criteria 253. The database result set contains relevant records, including business name, address, contact phone, latitude and longitude which include the unique ID of the associated video file 254. The search results are then displayed to the user 255.

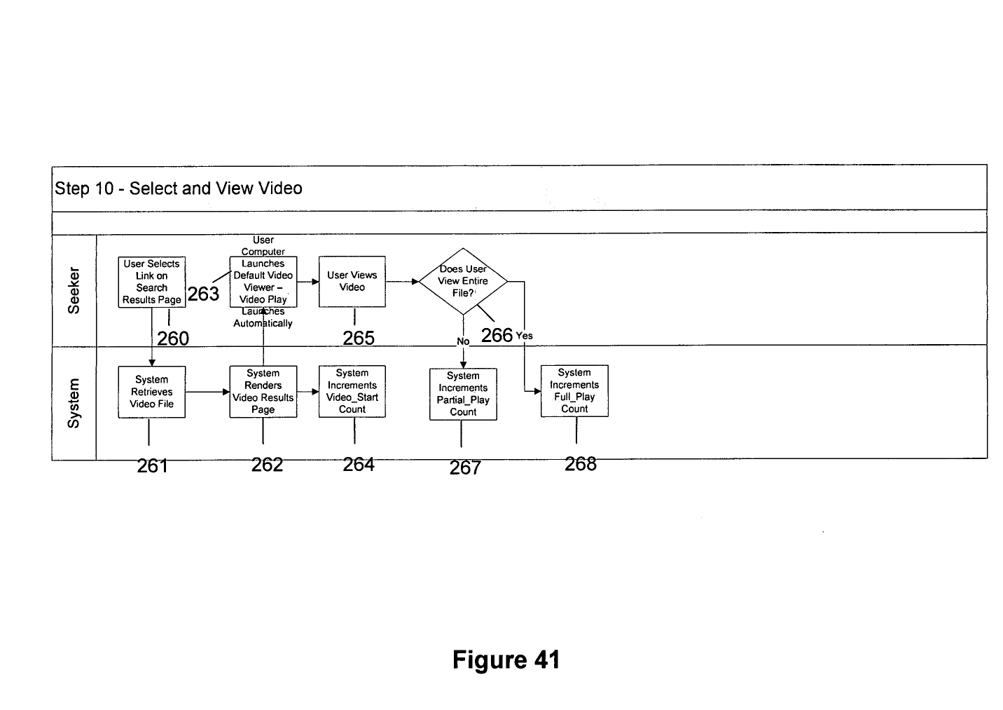

As shown in FIG. 41, the end user selects a link on the search results page 260. The system will then retrieve the video file using the associated unique ID of the video file 261 and will render the video results page to the end user 262.

The end user's computer then launches its default video viewer 263. The video player will launch automatically. The end user can then view the video in increments or as a full video 265. The system increments a counter 264 to track the number of times the video is displayed. If the end user views the entire file the system increments a full play counter 268. If the end user does not view the entire file, the system increments a partial play counter 267.

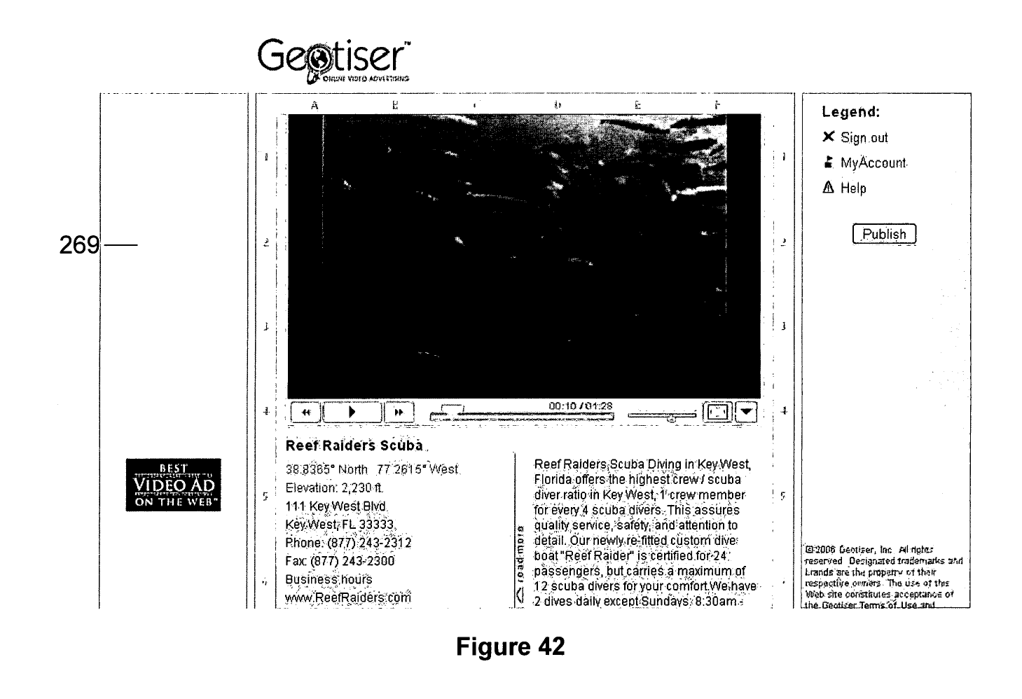

FIG. 42 illustrates the system screen 269 which displays the business or event advertisement to the end user. If the video advertisement has achieved the “Top 10” or “Best of” ranking, then a special logo highlighting the achievement is displayed on the page.

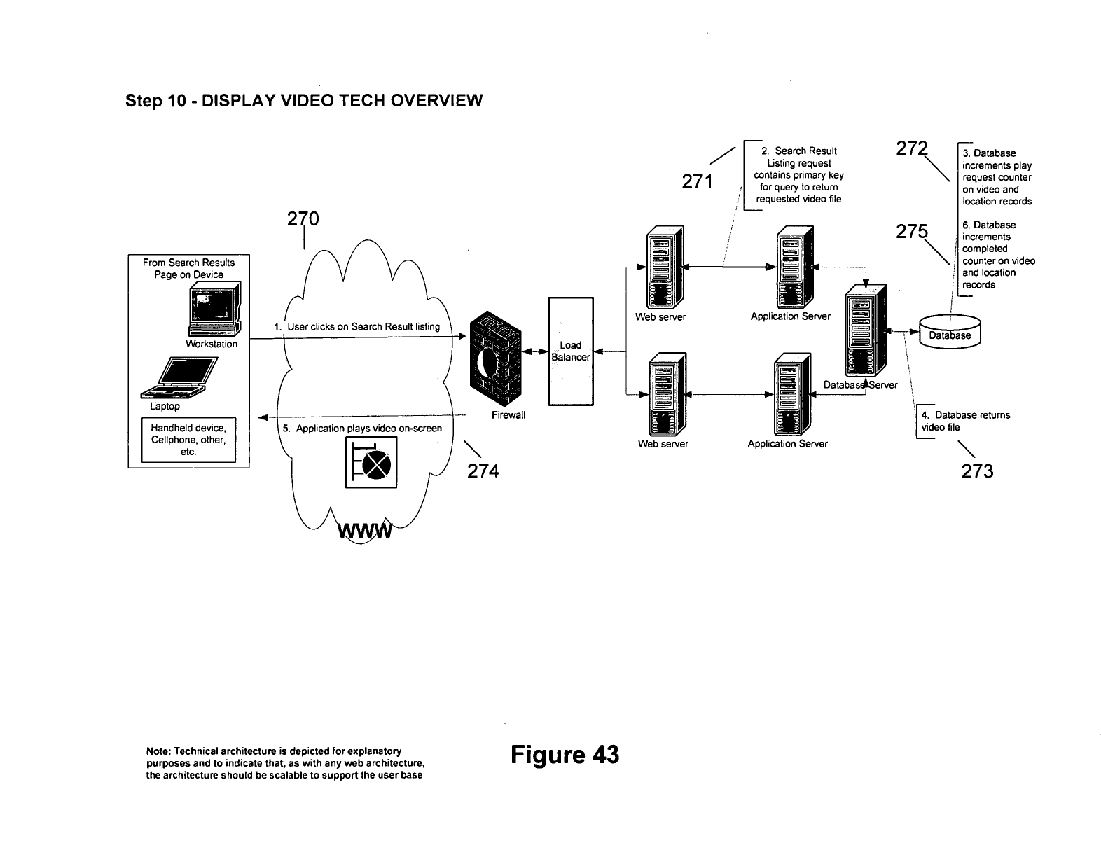

FIG. 43 shows the system for accessing the ad. The end user clicks on the Search Result listing 270 which contains the database table primary key to return the requested video file 271. The database then increments the Play Request Counter 272 on the video and location records, and returns video 273 file. The application plays the video on end user screen 274 and the database increments the Completed Counter on the video and location records 275.

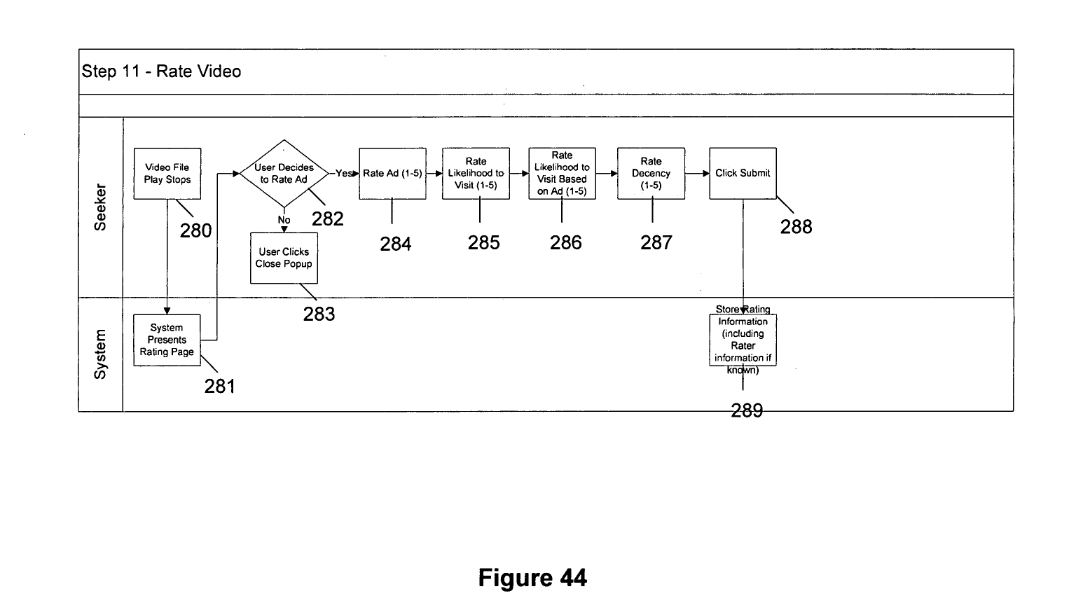

FIG. 44 illustrates the system for rating a video. When the video stops 280, a rating page may be displayed as a popup, mouse-over, inline display on the web page or as a standard webpage 281. If the end user does not want to rate the ad, the user may close the popup, mouse-over, inline display 283. The end user may decide to rate the ad on a scale of 1 to 5 284. The advertisement may be rated on several criteria, including the end user's likelihood to purchase a product, the creativity of the ad and whether the ad increased the likelihood of a purchase or visitation 285, 286.

Then, the end user clicks “Submit” 288 and the rating is stored and any information related to the video 289 and rater (if known). In one embodiment of the invention, the user may rate the advertisement for public decency in order to assess the advertisements suitability for viewing by viewer sub-segments 287. For example, if the advertisement is rated indecent once, or multiple times, it may trigger the third party operator to remove the advertisement from public viewing.

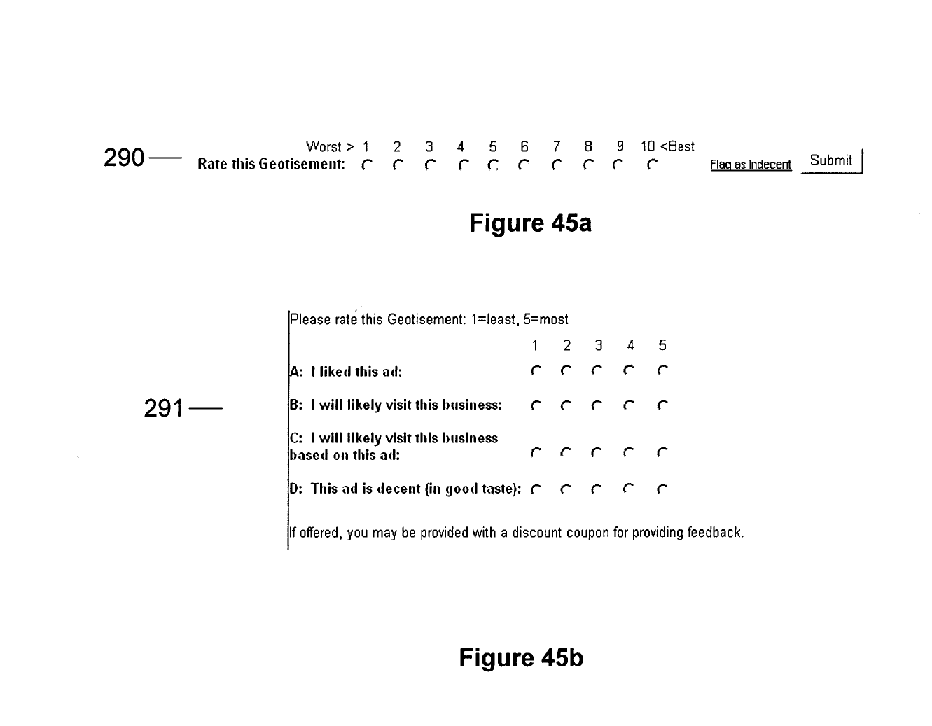

FIG. 45a depicts a simple rating form 290 in which the end user rates the advertisement from 1-10. The user may also flag the advertisement as indecent. FIG. 45b depicts a rating form 291 in which the user rates the advertisement as described 284, 285, 286.

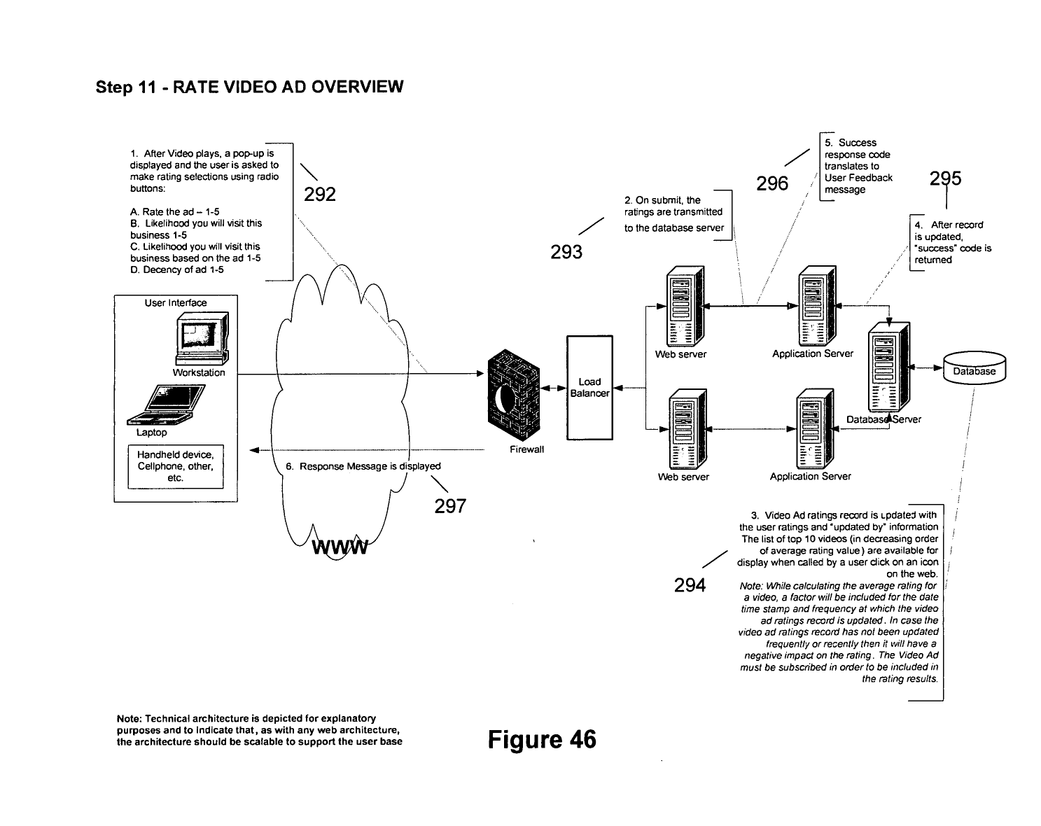

A technical overview of rating videos is shown in FIG. 46. Once the video has finished playing, a pop-up, mouse-over, inline display on the web page or standard webpage is displayed and the end user is asked to make rating selections within five categories dealing with their opinion of the ad, 292. Upon submission by the user, the submitted ratings are stored in the database which updates the user ratings 293. Based on this information, a list of the top ten videos in decreasing order of the average rating are available for display for the user 294.

After the record is updated with the rating information, a “success” code is returned, which the system converts to a “User Feedback message” 296 via a lookup table. This response message is displayed on the end user's interface 297. In one embodiment of the invention, the system may include the rating averages for an advertisement, a system date timestamp and frequency at which the ratings are updated to calculate the ranking. For example, advertisements which have not been viewed or rated frequently or recently may have a negative impact on the rating. In yet another embodiment, the advertisement must be subscribed to, paid for, or otherwise “current” in order to be included in the rating results.

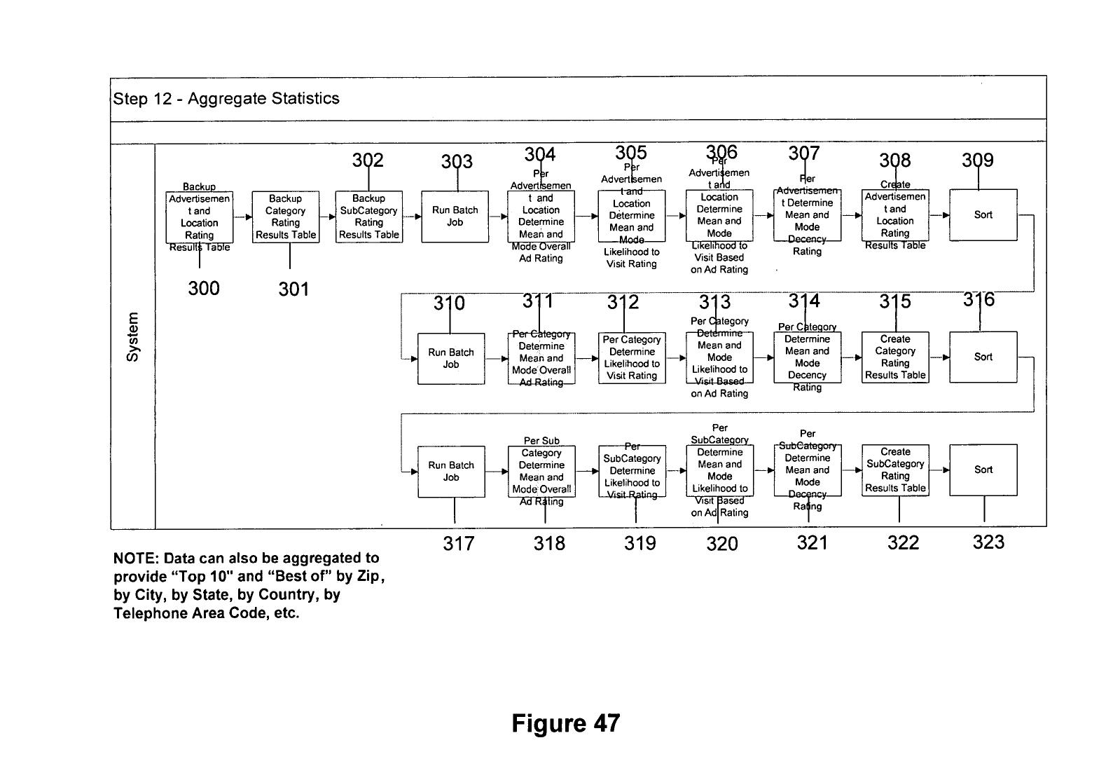

FIG. 47 illustrates extensive statistics maintained by the system. These contain statistics on the rating criteria as well as mean and mode data. In one embodiment of the invention, the system may calculate statistics for the advertisement within its location, within its category or sub-category. For example, the system can provide the advertiser, end-user or third party operator with a view of the effectiveness of the users advertisement within their geographic area and category, i.e. the advertisement for a shoe store may be effective when compared with a local competitors advertisement, but ineffective when compared with the advertisement of another shoe store when geographic location is not a consideration. Similarly, an advertisement may be rated better than average within a specific sub-category, but below average within the context of the broader category. For example, the advertisement for a scuba-diving shop may be rated well within the “Scuba-Diving” sub-category, but not be rated well within the broader “Outdoor Sports” category.

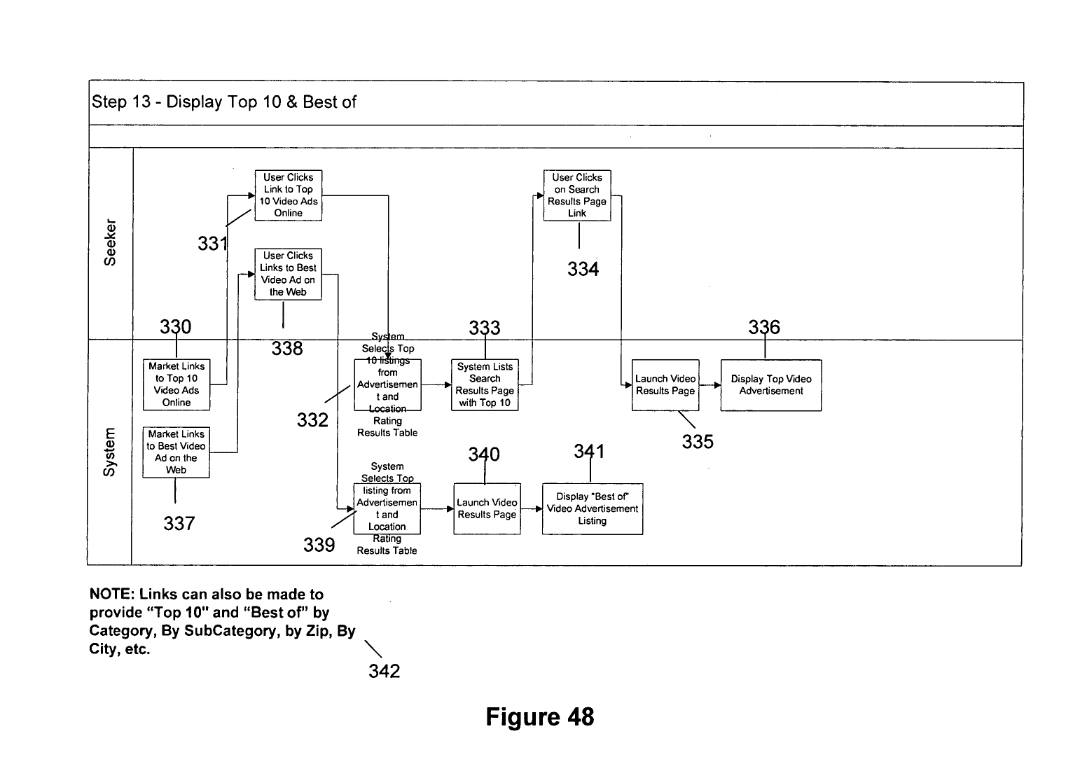

The “Top 10” and “Best of” applications are represented in FIG. 48. The system displays links to entries within these two categories 330, 337 and the end user clicks to see the results 331, 338. Then the system reveals as a list the “Top 10” and “Best of” based on the ratings table 332, 339. If the end user clicks to see the Top 10 Video Ads, the system calls up a search page with the Top 10 displayed 333. The end user can then click on a link of intent 334 which launches a video page 335 and displays the top Video Advertisement 336. Had the user clicked on “Best of” instead 338, the system would select the top listing advertisement and location rating results table 339 and launch the video page from there 340. The system then displays the top video Advertisement for the category 341. In one embodiment of the invention, the system may acquire the users location based on a user location provided via a global positioning system, via user profile or via other member information and display the “Top 10” and “Best of” based on those advertisements that are within geographic proximity to the user.

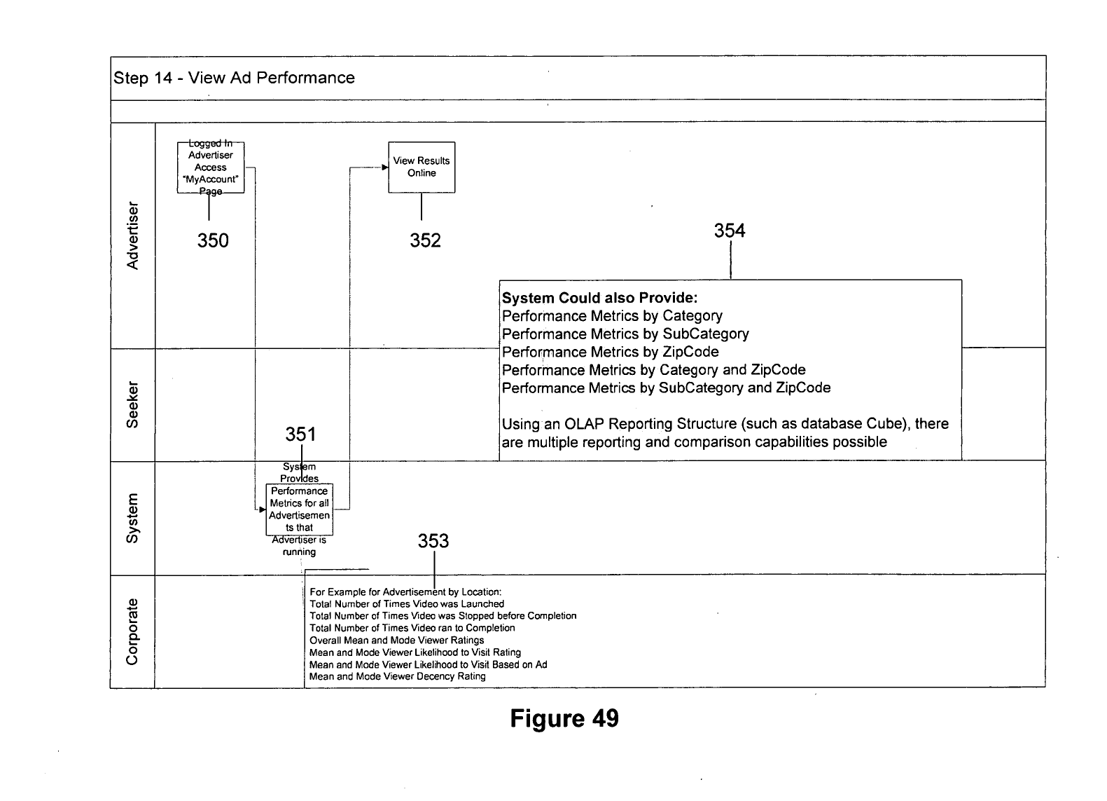

In FIG. 49 the logged in advertiser would access an account page 350. Following that the system would provide the “Performance Metrics of all Advertisements that Advertiser is running” 351. With this feature the advertiser would be able to view the results of the advertisement online 352. The system is also able to provide performance Metrics displayed by category, subcategory, zip code, category including zip code, and subcategory including zip code 353.

The invention can use an Online analytical processing (OLAP) Reporting structure which provides substantial reporting and comparison capabilities 354. A number of companies use (OLAP) and data mining technology to analyze complex data sets, especially those where patterns and relationships may not be obvious. For example, for an advertisement, the following can be displayed by location: the total number of times the video launched, videos stopped before completion, videos run to completion, the overall mean and mode viewer ratings, the mean and mode of the user to likely visit rating, their likelihood to visit based on ad, as well as the creativity rating based on the user. In this way, the advertiser is provided with valuable feedback regarding the ad which can be used to help the advertiser identify the demographics and desires of its customer base. In a further example, using OLAP or similar data analysis tools, the system could provide information to determine if an advertisement for a snow shovel is rated more highly in Chicago or New York, and during what days of the year the advertisement was rated most highly.

The present invention has been described with the reference to the preferred embodiment. The true nature and scope of the invention is to be determined with the reference to the attached claims.

1. A method for uploading rating a multimedia advertising comprising the following steps:
providing web service for storing a plurality of applications programs for permitting an advertiser to place a multimedia advertisement for review by an end user;
providing a first user interface for an advertiser to upload a multimedia advertisement with the web service; and
providing a second user interface for an end user to view the advertisement and rate the advertisement based upon at least one rating criteria.

2. A method for uploading and rating a multimedia advertising comprising the following steps:
providing a web service for storing a plurality of secure application programs for permitting an advertiser to place a multimedia advertisement for review and rating by an end user;
providing a first user interface for an advertiser to log on, subscribe and upload a multimedia advertisement with the web service; and
providing a second user interface for an end user to view the uploaded advertisement and to rate the advertisement based upon at least one rating criteria.

3. A method for uploading and rating advertising comprising the following steps:
providing a web service for storing a plurality of applications programs for permitting an advertiser to place a multimedia advertisement for review by an end user;
providing a first user interface for an advertiser to log on, subscribe and upload a multimedia advertisement on the web service;
providing a second user interface for an end user to view the advertisement and rate the advertisement based upon a plurality of rating criteria; and
providing a third interface for displaying a plurality of advertisements listed according to their ratings.

4. A system for uploading, displaying and rating multimedia advertisement:
a web service for storing a plurality of application programs for permitting an advertiser to place a multimedia advertisement for viewing by end users;
a first user interface associated with the web service for enabling an advertiser to log in, subscribe and to upload said multimedia advertisement; and
a second user interface associated with the web browser for enabling an end user to access the web service to select a multimedia advertisement for viewing and for inputting rating data; and
a third interface for providing a listed ranking of the said first user interface enabling the advertiser to review and search rating data.

5. A system for uploading, displaying and rating multimedia advertisement:
a web service for storing a plurality of application programs for permitting an advertiser to place a multimedia advertisement for viewing by end users;
a first user interface associated with the web service for enabling an advertiser to log in, subscribe and to upload said multimedia advertisement; to associate the advertisement to one or more geographic locations and to offer a special offer or discount specific to each location;
a second user interface associated with the web browser for enabling an end user to access the web service to search for and select a multimedia advertisement for viewing and for inputting rating data; and
a third interface for providing a listed ranking of the said first user interface enabling the advertiser to review and search rating data.
